(19) United States
(12) Patent Application Publication
(10) Pub. No.: US 2019/0066454 A1
(43) Pub. Date: Feb. 28, 2019

(54) SHOPPING ASSISTANCE SYSTEM

(71) Applicant: Panasonic Intellectual Property Management Co., Ltd., Osaka (JP)

(72) Inventors: Tsuyoshi KATAYAMA, Kyoto (JP); Hideto ADACHI, Tokyo (JP); Masamichi NAKAGAWA, Osaka (JP); Satoshi NONAKA, Yamanashi (JP); Ryoji INUTSUKA, Nara (JP); Kenji FUKASE, Tokyo (JP); Yoshihiko MATSUKAWA, Nara (JP); Atsushi MARUYAMA, Kanagawa (JP); Junichi TAGAWA, Tokyo (JP); Hironori KUMAGAI, Tokyo (JP); Shozo FUKUSHIMA, Osaka (JP); Kei KOBAYASHI, Osaka (JP); Akihito SAKANAKA, Osaka (JP)

(73) Assignee: Panasonic Intellectual Property Management Co., Ltd., Osaka (JP)

(21) Appl. No.: 16/080,417

(22) PCT Filed: Feb. 17, 2017
(86) PCT No.: PCT/JP2017/005981

§ 371 Date: Aug. 28, 2018

(30) Foreign Application Priority Data
Feb. 29, 2016 (JP) 2016-038382

(51) Int. Cl. G07G 1/00; G06Q 20/20; G07G 1/14; B65D 1/38

(52) U.S. Cl. CPC G07G 1/0072; B65D 1/38; G07G 1/14; G06Q 20/208

(57) ABSTRACT

The shopping assistance system includes a basket body, a management system and a packing machine. The shopping basket includes a basket body, a goods information receiver and a transmitter. The basket body allows goods to be put in. The goods information receiver is configured to read respective goods information from each of the goods to acquire pieces of goods information on the goods. The transmitter is configured to transmit the pieces of goods information acquired through the goods information receiver. The management system includes a receiver configured to receive the pieces of goods information from the transmitter. The packing machine is configured to transfer the goods put in the basket body together from the basket body to a container.

### TECHNICAL FIELD

The invention relates generally to shopping assistance systems and, more particularly, to a shopping assistance system configured to assist customer's purchase of goods or products.

### BACKGROUND ART

A system directed at an unmanned store with no clerk (POS system) is described in Patent Literature 1.

The system described in Patent Literature 1 is composed of a basket that allows one or more goods (or products) to be put in, and a transaction terminal device. The basket includes a scanner configured to read goods (or product) information (goods data), and a transmitter circuit configured to transmit the goods information to an outside. The transaction terminal device includes a receiver circuit configured to receive the goods information, scales (weighing scale) configured to weigh one or more goods put in the basket, and a controller configured to compare a measurement value by the scales with respective weight data corresponding to their respective goods information. The transaction terminal device is configured to perform a checkout process when the measurement value by the scales matches the total weight derived from the respective weight data.

The configuration described in Patent Literature 1 however requires, when goods are put in the basket, store employees (clerks) or a customer to transfer the goods into a container such as a shopping bag one by one after the checkout process. This may consequently take a long time from the start of the checkout process to the customer getting the goods, thereby resulting in an increase in shopping time such as waiting time at a checkout lane.

### CITATION LIST

### Patent Literature

Patent Literature 1; JPH05-8964 A

### SUMMARY OF INVENTION

With the foregoing in view, it is an object of the present invention to provide a shopping assistance system capable of reducing shopping time.

A shopping assistance system according to an aspect of the present invention includes a shopping basket, a management system and a packing machine. The shopping basket includes a basket body, a goods (or product) information receiver and a transmitter. The basket body allows goods to be put in. The goods information receiver is configured to read respective goods (or product) information from each of the goods to acquire pieces of goods information on the goods. The transmitter is configured to transmit the pieces of goods information acquired through the goods information receiver. The management system includes a receiver configured to receive the pieces of goods information from the transmitter. The packing machine is configured to transfer the goods put in the basket body together from the basket body to a container.

### BRIEF DESCRIPTION OF DRAWINGS

FIG. 1 is a block diagram of a shopping assistance system in accordance with an embodiment of the present invention;

FIG. 2 is an exterior perspective view of the shopping assistance system;

FIG. 3 is an exterior perspective view of a shopping basket in the shopping assistance system;

FIG. 4A is a sectional view of the shopping basket that holds goods (or products);

FIG. 4B is a sectional view of the shopping basket when a base plate thereof is moved from a state where the shopping basket holds the goods;

FIG. 4C is a sectional view of the shopping basket with a lower opening thereof opened;

FIG. 5A is a schematic perspective view illustrating a first state of a body mechanism in a packing machine of the shopping assistance system;

FIG. 5B is a schematic perspective view illustrating a second state of the body mechanism in the packing machine;

FIG. 6A is a sectional view of the body mechanism in the packing machine in the first state;

FIG. 6B is a sectional view of the body mechanism in the packing machine during transition from the first state to the second state;

FIG. 6C is a sectional view of the body mechanism in the packing machine in the second state;

FIG. 7A is a sectional view of the body mechanism in the packing machine during transition from the second state to the first state;

FIG. 7B is a sectional view of the body mechanism in the packing machine in the first state;

FIG. 8 is a flow chart showing an operation of the shopping assistance system;

FIG. 9 is a sequence chart showing an operation of the shopping assistance system;

FIG. 10 is an exterior perspective view of a shopping assistance system as a first modified example in accordance with the embodiment of the present invention;

FIG. 11A is a plan of a shopping assistance system as a second modified example in accordance with the embodiment of the present invention; and

FIG. 11B is a sectional view taken along an X1-X1 line in FIG. 11A.

### DESCRIPTION OF EMBODIMENTS

### (1) Schema

A shopping assistance system according to the present embodiment is a system, for assisting customers' shopping, which is introduced to retail stores. Examples thereof include convenience stores, supermarkets, department stores, drugstores, electronics retail stores, home centers (hardware stores) and the like.

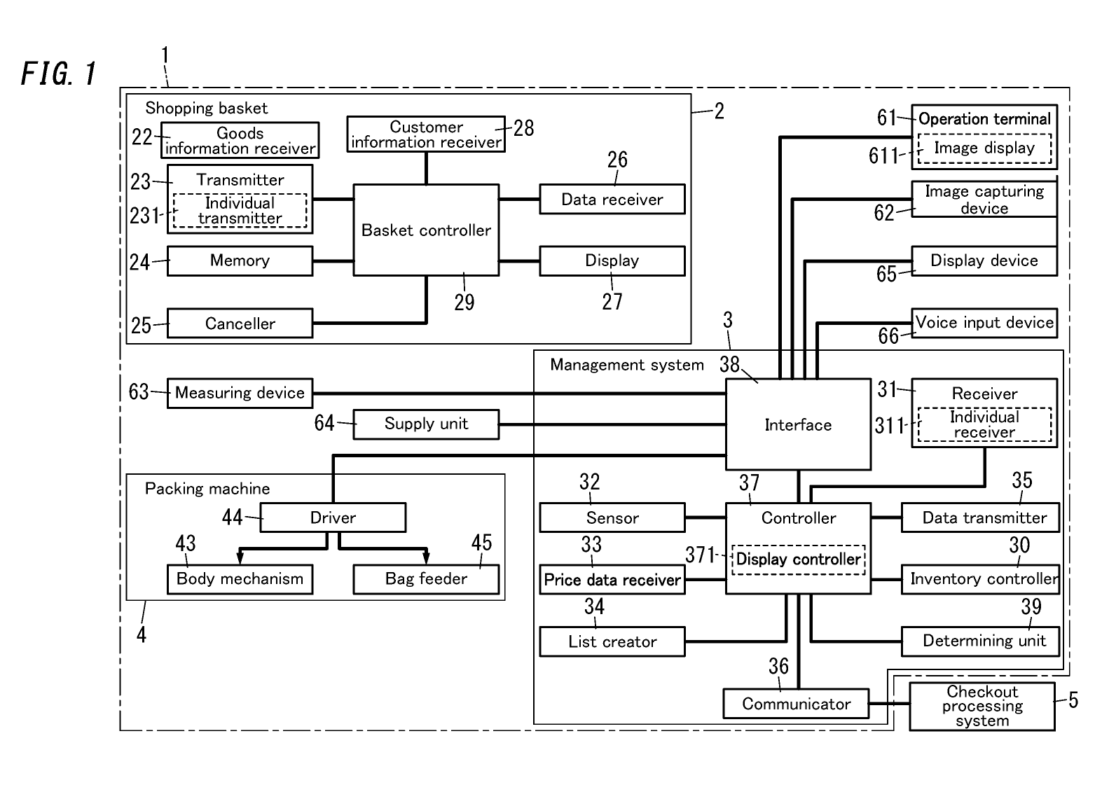

As shown in FIG. 1, a shopping assistance system 1 includes a shopping basket 2, a management system 3 and a packing machine 4.

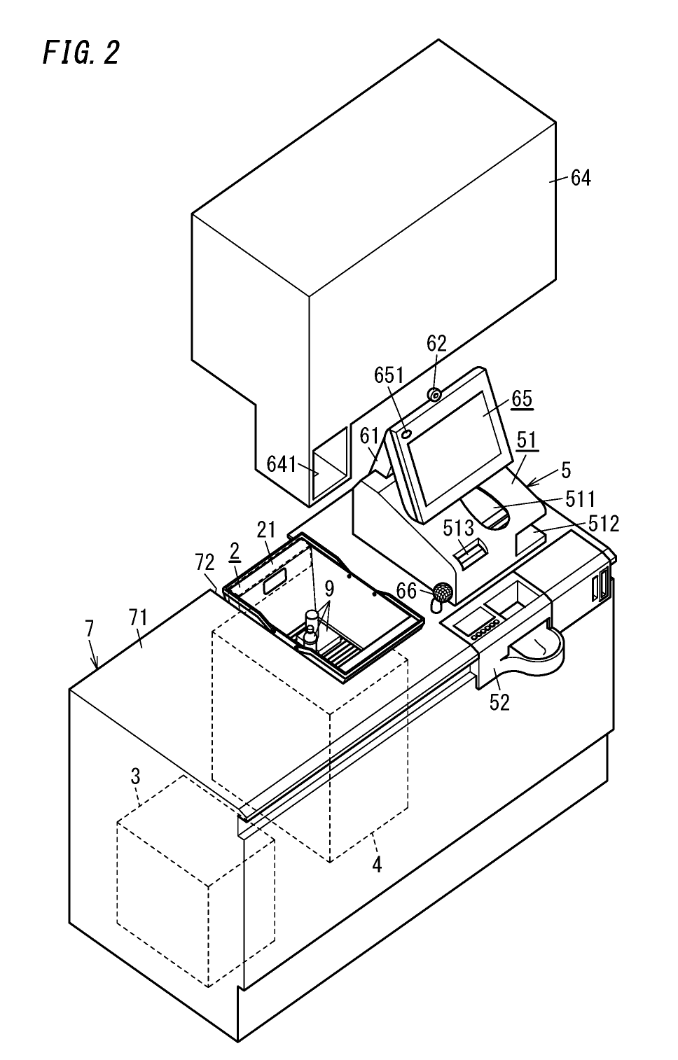

The shopping basket 2 includes a basket body 21 (see FIG. 2), a goods (or product) information receiver 22 and a transmitter 23. The basket body 21 allows goods (or products) 9 (see FIG. 2) to be put in. The goods information receiver 22 is configured to read respective goods (or product) information from each of the goods 9 to acquire pieces of goods information on the goods 9. The transmitter 23 is configured to transmit the pieces of goods information acquired through the goods information receiver 22. That is, the shopping basket 2 has a function of not only holding the goods 9 chosen by customers in a store but also reading the pieces of goods information from the goods 9 to perform transmission thereof.

The management system 3 includes a receiver 31. The receiver 31 is configured to receive the pieces of goods information transmitted from the transmitter 23. The management system 3 is configured to communicate with a checkout processing system 5 configured to perform, for example a checkout process. In this example, the checkout processing system 5 enables the management system 3 to perform a checkout process of the goods 9 based on the pieces of goods information received from the shopping basket 2 (transmitter 23) through the receiver 31.

The packing machine 4 is configured to transfer the goods 9 put in the basket body 21 all together from the basket body 21 to the container, thereby performing packing of the goods 9. Herein, the “packing” means not only packing the goods 9 into the container but also housing (putting) the goods in any container (receptacle) that allows the goods 9 to be put into. For example, the packing machine 4 is installed in a checkout counter in the store. In this example, the packing machine 4 will perform, when the shopping basket 2 is placed at a predetermined location, packing of the goods 9 therein all together. This example enables customers to get the goods 9 put into the container by just putting, at the predetermined location, the shopping basket 2 which the goods 9 to be purchased are put in. It is therefore possible for store employees (clerks) or customers to save labor and time needed for the packing.

Stores which the shopping assistance system 1 is introduced into enable customers to finish purchasing goods 9 by a series of processes of choosing goods 9 in the stores, putting them in the shopping basket 2, performing the checkout process thereof and packing the goods 9 all together. That is, the shopping assistance system 1 is able to: provide the management system 3 with pieces of goods information on the goods 9 to be utilized for the checkout process and the like without separating the goods 9 put in the shopping basket 2; and transfer the goods 9 all together to a container. Thus, with the shopping assistance system 1, it is possible to reduce, for example, a time from the start of the checkout process to customers getting their goods while saving clerks' labor and customers' labor, thereby reducing customers' shopping time.

### (2) Details

The shopping assistance system 1 according to the present embodiment will be explained in detail below.

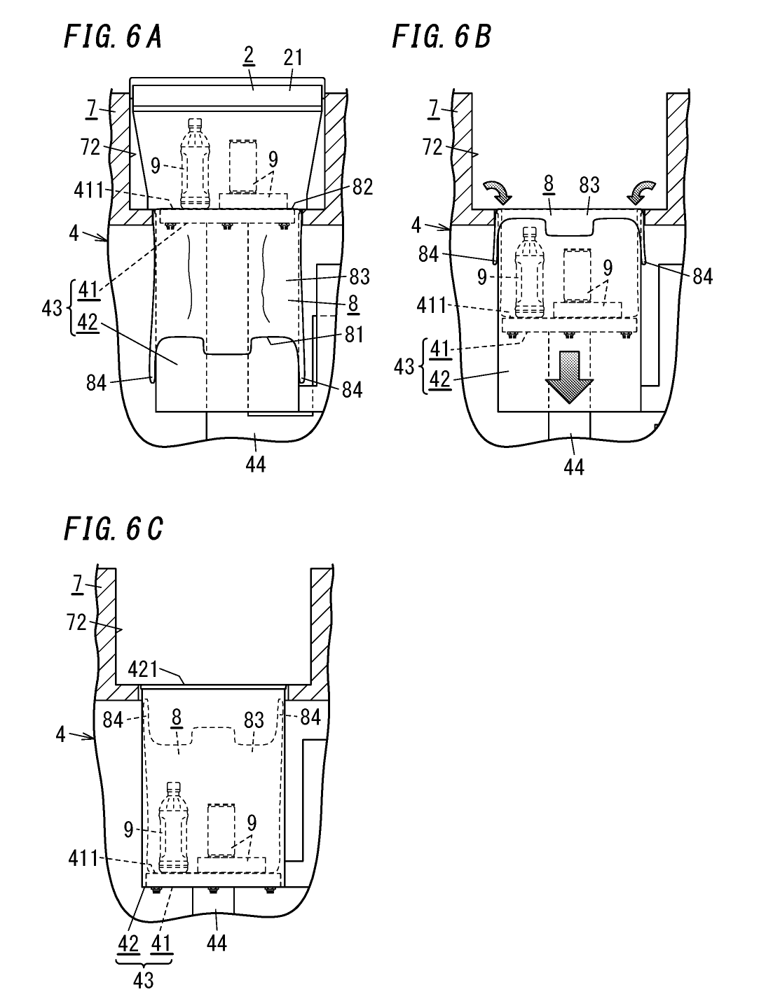

In the present embodiment, a convenience store is exemplified as a store which the shopping assistance system 1 is introduced into. In addition, a bag 8 made of polyethylene as what is called a shopping bag (or a plastic shopping bag) (see FIG. 6A) is exemplified as the container. Since the container is the bag 8, the “packing” to be performed by the packing machine 4 means “bagging”. Note that the packing machine 4 is not limited to the configuration to use bags 8 as long as it is configured to put goods (or products) 9 into the container. For example, it is configured to put (pack) goods 9 into a container such as a reusable shopping bag, a takeout container, or a case.

(2.1) Overall Structure

Herein, the overall structure of the shopping assistance system 1 according to the present embodiment will be first explained. As shown in FIG. 1, the shopping assistance system 1 includes an operation terminal 61, an image capturing device 62, a measuring device 63, a supply unit 64, a display device 65 and a voice input device 66 besides the shopping basket 2, the management system 3 and the packing machine 4.

The operation terminal 61 is a terminal configured to allow clerks to enter an operation into. The image capturing device is a camera configured to photograph customers. The measuring device 63 is configured to weigh the shopping basket 2 with goods 9 (see FIG. 2) put in the basket body 21 (see FIG. 2). The supply unit 64 is configured to supply customers with one or more specific goods (or products) such as cigarettes. The display device 65 is a device configured to display various kinds of information to customers. The voice input device 66 is a microphone configured to pick up customers' voice. The shopping basket 2, the management system 3 and the packing machine 4 will be described later in detail.

Here, the management system 3 is configured to communicate with the checkout processing system 5. The checkout processing system 5 is composed of, for example a point of sale (POS) terminal. The checkout processing system 5 is configured to perform a checkout process of paying for goods 9 (see FIG. 2) based on pieces of goods (or product) information transmitted from the management system 3. In the present embodiment, the checkout processing system 5 is not included in components of the shopping assistance system 1, but may be included in the components of the shopping assistance system 1.

In the present embodiment, the management system 3 is connected with each of the operation terminal 61, the image capturing device 62, the measuring device 63, the supply unit 64, the display device 65 and the voice input device 66. The management system 3 is configured to communicate with the checkout processing system 5, thereby enabling the checkout processing system 5 to transmit data to, for example the display device 65 through the management system 3.

As shown in FIG. 2, one counter desk 7 is installed at, for example a checkout lane in the store, and provided with the management system 3 and the packing machine 4 along with the checkout processing system 5. The counter desk 7 is further provided with the operation terminal 61, the image capturing device 62, the measuring device 63 (see FIG. 1), the display device 65 and the voice input device 66. The supply unit 64 is suspended from a ceiling and provided above the counter desk 7. In the example of FIG. 2, the management system 3 and the packing machine 4 are built in the counter desk 7. The packing machine 4 is disposed at a location that is a substantially central portion of the counter table 7 as viewed from a front side of the counter desk 7. The checkout processing system 5 is disposed at a right side of the packing machine 4 as viewed from the front side of the counter desk 7. One store may be provided with two or more counter desks 7, each of which is provided with the management system 3, the packing machine 4, the checkout processing system 5 and the like.

The checkout processing system 5 includes a body 51 installed on an upper surface 71 of the a counter desk 7, and a cash unit 52 configured to accept and dispense cash. The body 51 includes a computer as a main component, and is configured to cause a processor of the computer to execute a program stored in a memory of the computer, thereby performing a checkout process such as calculation of checkout amount based on one or more pieces of goods information received from the management system 3. The body 51 includes a first card reader 511 configured to read credit card information for payment, a second card reader 512 configured to read member's card information, loyalty card information or the like, and a printer 513 configured to issue a receipt. Information such as, for example, detailed statement, payment amount and purchase date and time is described in the receipt. The first card reader 511 is not limited to a reader for credit cards, but may be a reader for payment cards such as electronic money cards, or a reader such as a personal digital assistant with a reader function.

The checkout processing system 5 is configured to communicate with a store server installed in the store. The store server is configured to communicate with a center server installed in a headquarters, which manages a plurality of stores, via a network such as the Internet. The checkout processing system 5 communicates with the store server and the center server, thereby respectively transmitting and receiving, for example respective information on goods 9 and customers to and from the store server and the center server.

The operation terminal 61 and the display device 65 are installed on the body 51. The operation terminal 61 is directed backward (toward clerk side) as viewed from the front side of the counter desk 7. The display device 65 is directed forward (toward customer side) as viewed from the front side of the counter desk 7. The image capturing device 62 is installed on the display device 65. A lens of the image capturing device 62 is directed forward (toward customer side) as viewed from the front side of the counter desk 7.

The counter desk 7 is formed with a recess 72 that opens in a substantially central portion of the upper surface 71 in a lengthwise direction thereof (lateral direction). The recess 72 serves as a space that allows the basket body 21 of the shopping basket 2 to be put in. In the example of FIG. 2, although the shopping basket 2 is put in the recess 72, the shopping basket 2 is not fixed in place because when moving in the store, customers are to carry the shopping basket 2 by their hand or carry the shopping basket 2 in a shopping cart. The recess 72 opens backward (toward clerk side) as viewed from the front side of the counter desk 7. The packing machine 4 and the measuring device 63 (see FIG. 1) are installed under the recess 72. The voice input device 66 is installed between the recess 72 and the body 51 on the upper surface 71 of the counter desk 7.

The operation terminal 61 includes, for example a touch screen, and has not only a function that allows clerks to enter an operation into but also a function configured to display various information. The operation terminal 61 includes at least a function as an image display 611. The image display 611 is configured to display customers' image based on image data contained in a request signal from the management system 3. Note that details thereof will be described in detail in “(3.3) Age verification process”. In addition, the operation terminal 61 is utilized for maintenance of the shopping assistance system 1, and the like.

The display device 65 includes, for example a touch screen. The display device 65 functions as a user interface that allows customers to enter an operation into, in addition to display of various information. The display device 65 further includes a voice output device 651 including a speaker, and is also able to output voice. That is, the display device 65 is able to provide customers with various information by the display or the voice. As an example, the checkout processing system 5 may provide customers with checkout amount (payment amount) and, at start and end of a checkout process, messages of “Welcome” and “Thank you very much”, respectively. It is accordingly possible to give customers a sense of affinity like clerk service. For example, customers are to operate the display device 65 to select one of payment methods to pay the checkout amount, thereby finishing checkout.

The display device 65 may also provide customers with an operating procedure for the shopping assistance system 1. In this example, preferably when the shopping basket 2 is placed at the predetermined location, the display device 65 then represents each step of the operating procedure sequentially, thereby confirming whether or not cigarettes are purchased, etc. It is accordingly possible to assist customers to operate the shopping assistance system 1 with no clerk's assistance. Such information may be represented by at least one of the display and the voice through the display device 65. That is, such information may be represented by any one of the display and the voice, or represented by a combination of the display and the voice.

Positional relationship and shape of each part of the shopping assistance system 1 and the checkout processing system 5 are merely exemplified, and may be modified appropriately. For example, the supply unit 64 may be installed not above the counter desk 7 but beside the counter table 7. The packing machine 4 and the recess 72 may be arranged at one end (left end or right end) of the counter desk 7 in the lengthwise direction (lateral direction). The recess 72 opening backward (toward clerk side) as viewed from the front side of the counter desk 7 is not an essential configuration of the shopping assistance system 1. Also, the recess 72 formed in the counter desk 7 is also not an essential configuration of the shopping assistance system 1. Alternatively, a space that allows the basket body 21 of the shopping basket 2 to be put in may be provided on the upper surface 71 of the counter desk 7.

(2.2) Shopping Basket

A configuration of the shopping basket 2 will be explained in detail below.

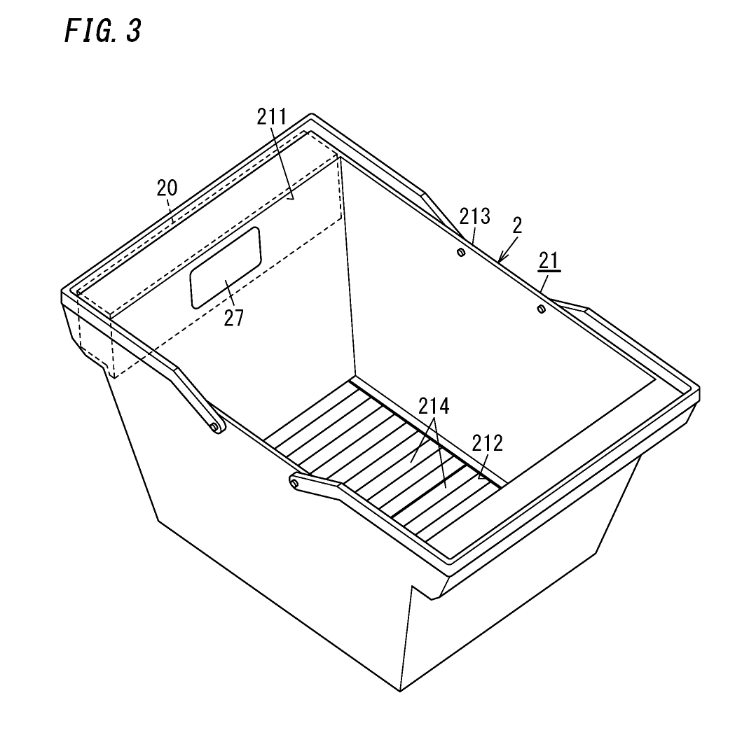

As shown in FIG. 3, the shopping basket 2 includes the basket body 21 and a circuit block 20. The basket body 21 is in the shape of a box that has at least an opening at the top, and allows goods 9 to be put in. The circuit block 20 includes a battery, and various circuits and modules each of which is configured to receive electric power from the battery to be activated. The circuit block 20 is built in part of the basket body 21. Note that the basket body 21 exposes, from an inner side surface thereof, at least a screen of a display 27 included in the circuit block 20. In addition, the basket body 21 exposes, from an outer side surface thereof, part of the circuit block 20 such as the goods information receiver 22 and a canceller 25 to be described later.

As shown in FIG. 3, the basket body 21 includes a body 213 and a base plate 214. Each of body 213 and the base plate 214 is made of synthetic resin.

The body 213 is formed with an upper opening 211 and a lower opening 212, and allows goods 9 to be put in. The base plate 214 is attached to the body 213 to allow opening and closing of the lower opening 212. Here, the lower opening 212 has a shape and dimensions that allow goods 9 to pass through the lower opening 212. The base plate 214 closing the lower opening 212 enables goods 9 to be put in an internal space surrounded by the body 213 and the base plate 214. On the other hand, the base plate 214 opening the lower opening 212 enables the goods 9 to exit from the internal space through the lower opening 212.

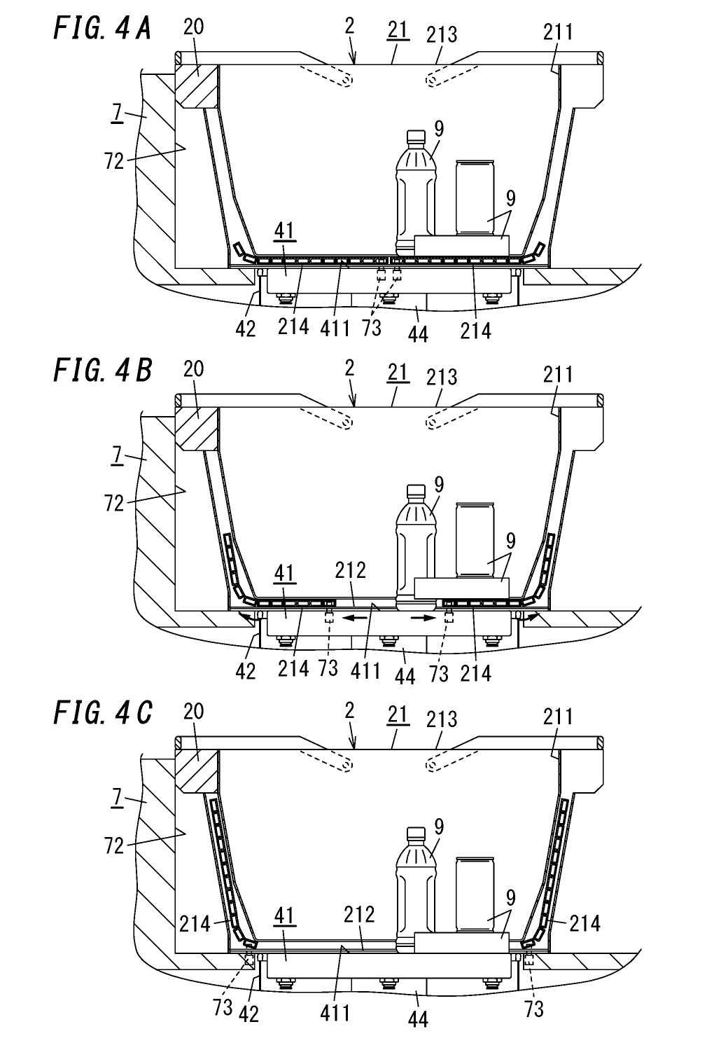

That is, the body 213 is formed with openings in both of an upper surface and a lower surface thereof (upper opening 211 and lower opening 212). The basket body 21 is configured such that the base plate 214 moves relative to the body 213 and thereby the lower opening 212 of the body 213 is opened and closed. That is, when the base plate 214 is in a closing position, the base plate 214 closes the lower opening 212 of the body 213 (see FIG. 4A). On the other hand, when the base plate 214 moves from the closing position to an opening position, it then opens the lower opening 212 of the body 213 (see FIG. 4c).

In the present embodiment, the basket body 21 includes a pair of base plates 214 arranged side by side in a lengthwise direction of the lower opening 212. The pair of base plates 214 is held by the body 213 so as to allow the pair of base plates 214 to slide along the lower surface of the body 213. When the pair of base plates 214 is in the closing position, the pair of base plates 214 is butted to each other in the lengthwise direction of the lower opening 212, thereby closing the lower opening 212 of the body 213. When the pair of base plates 214 is in the opening position, the pair of base plates 214 is apart from each other in the lengthwise direction of the lower opening 212, thereby opening the lower opening 212 of the body 213. When the pair of base plates 214 moves from the closing position to the opening position, the pair of base plates 214 moved away from the lower opening 212 then is housed in inside side walls of the body 213 (between each pair of an inner side surface and an outer side surface thereof).

With the configuration stated above, as shown in FIGS. 4A to 4C, the pair of base plates 214 moves from the closing position to the opening position with goods 9 put in the basket body 21, thereby enabling the goods 9 to exit from the body 213 through the lower opening 212. That is, when the pair of base plates 214 moves with the basket body 21 put at the predetermined location (in the embodiment, on a bottom of the recess 72 in the counter desk 7), the goods 9 in the basket body 21 move to the predetermined location. Specifically, a pair of pins 73 for moving the pair of base plates 214 protrudes from the bottom of the recess 72 in the counter desk 7. As shown in FIGS. 4A to 4C, the packing machine 4 to be described later moves the pair of pins 73 away from each other, thereby moving the pair of base plates 214 from the closing position to the opening position. When the basket body 21 is taken away from the location shown in FIG. 4C, the goods 9 are then left on the bottom of the recess 72.

After the goods 9 in the basket body 21 exit from the basket body 21, the shopping basket 2 is collected from the counter desk 7. The shopping basket 2 collected is moved to a basket area, for example near an entrance of the store. A plurality of shopping baskets 2 is placed in the basket area.

As shown in FIG. 1, the circuit block 20 includes the goods information receiver 22, the transmitter 23, a memory 24, the canceller 25, a data receiver 26, the display 27, a customer information receiver 28 and a basket controller 29.

The goods information receiver 22 is configured to read respective goods information from goods 9 put in the basket body 21 to acquire pieces of goods information on the goods 9. Herein, the “goods information” is information for identifying each of goods 9 (goods (or product) identification code), and examples thereof in Japan include Japanese Article Number (JAN) code and the like. Examples of the goods identification code further include European Article Number (EAN) code in Europe, Universal Product Code (UPC) in USA and the like.

The goods information receiver 22 is exposed from the outer side surface of the basket body 21. The goods information receiver 22 is a barcode reader, and optically reads a barcode that each of the goods 9 carries to acquire goods information thereon. Therefore, a customer picks up each of goods 9 to show it to the goods information receiver 22 and then puts it in the basket body 21, thereby enabling the goods information receiver 22 to complete acquisition of respective goods information from the goods 9 put in the basket body 21. The goods information receiver 22 is not limited to the barcode reader, but examples thereof may further include a reader configured to read a two-dimensional code, and a tag reader configured to read goods information from a radio-frequency identification (RFID) tag in a contactless manner.

The goods information receiver 22 may also be configured to read goods information from, for example each image of goods 9. In this example, the goods information receiver 22 includes an image sensor configured to photograph goods 9 inside or outside the basket body 21. The goods information receiver 22 may specify respective goods information of the goods 9 by performing image recognition processing with respect to each of the goods 9, extracting feature such as outline, color and texture information therefrom, and verifying by comparing the feature with a template stored for each of goods 9 in advance. In this example, the goods information receiver 22 may utilize information read through the barcode reader as auxiliary information for reading goods information from each image of the goods 9. Alternatively, the barcode reader may be omitted when it is possible to sufficiently read goods information only from each image of goods 9.

The transmitter 23 is configured to transmit pieces of goods information acquired through the goods information receiver 22 to the management system 3. In the present embodiment, the transmitter 23 is composed of a communication module configured to perform two-way communication with the receiver 31 of the management system 3 (see FIG. 1). The transmitter 23 may communicate with the receiver 31 by optical wireless communication whose medium is radiation such as infrared radiation or visible radiation. Among different types of wireless communication, especially, near field type communication (near field wireless communication) having a narrow communication area is applicable because the transmitter 23 transmits pieces of goods information with the basket body 21 put in the counter desk 7.

The transmitter 23 further includes an individual transmitter 231 configured to individually transmit pieces of goods information. For example, the transmitter 23 may transmit the pieces of goods information all together to the management system 3, and also transmit the pieces of goods information one by one to the management system 3 through the individual transmitter 231. The individual transmitter 231 may transmit goods information directly derived from the goods information receiver 22, or transmit the goods information read from the memory 24 to be described later. A communication type of the individual transmitter 231 may be different from a communication type of the transmitter 23 when it transmits pieces of goods information all together. In the present embodiment, the individual transmitter 231 will perform communication with the management system 3 by wireless communication whose medium is radio such as, e.g., Wi-Fi (trademark) or Bluetooth (trademark).

The memory 24 is configured to store pieces of goods information. For example, whenever the goods information receiver 22 reads goods information, the goods information is stored in the memory 24. The transmitter 23 may transmit pieces of goods information stored in the memory 24 all together to the management system 3, or divide the pieces of goods information into packets to transmit the packets to the management system 3. In the present embodiment, the memory 24 stores goods information acquired through the goods information receiver 22 and the number thereof (i.e., acquisition count of goods information by the goods information receiver 22). For example, when there is pieces of goods information as respective goods information on three goods 9 that include two goods 9 of “A” and one item of goods (or one product) of “B”, the memory 24 stores goods information on “A”, “2” as count thereof, goods information on “B”, and “1” as count thereof. For example, when the transmitter 23 succeeds in transmitting the pieces of goods information to the management system 3, the pieces of goods information stored in the memory 24 is deleted.

The canceller 25 is configured to receive a cancel operation for deleting at least one piece of goods information from the pieced of goods information stored in the memory 24. For example, even if goods information is read through the goods information receiver 22 and then stored in the memory 24, the canceller 25 receives a cancel operation thereof, thereby enabling the deletion thereof from the memory 24. Specifically, the canceller 25 includes a cancel button that is disposed at an operable location by customers such as an outer side surface of the basket body 21. The cancel operation is an operation for causing the goods information receiver 22 to read goods information to be deleted during a constant time starting when the cancel button is pushed (e.g., five seconds), or while the cancel button is being pushed. Customers perform the cancel operation enables deletion of one or more pieces of goods information selected by the cancel operation from the memory 24.

The data receiver 26 is configured to receive display data transmitted from a data transmitter 35 of the management system 3 (see FIG. 1). The display data are data to be represented by the display 27, such as an advertisement or recommendation information suitable for customers. In the present embodiment, the data receiver 26 is composed of a communication module configured to perform two-way communication with the data transmitter 35. Moreover, the one communication module configured to perform two-way communication with the management system 3 is provided as not only the data receiver 26 and but also the individual transmitter 231. The data receiver 26 is therefore configured to perform communication with the data transmitter 35 by wireless communication whose medium is radio such as, e.g., Wi-Fi (trademark) or Bluetooth (trademark).

The display 27 is configured to perform display based on the display data received by the data receiver 26. The display 27 includes, for example a liquid crystal display (LCD). The display 27 functions as a browser configured to display a picture according to the display data as content delivered (transmitted) from the data transmitter 35 of the management system 3. Note that the display 27 may include a function as a user interface that allows customers to enter an operation into, in addition to display of various information like, for example a touch panel display.

The customer information receiver 28 is configured to acquire customer information of a customer to put one or more goods in the basket body 21. The customer information receiver 28 is composed of, for example, a card reader configured to read customer information from various cards such as member's cards, loyalty cards and credit cards. The customer information receiver 28 may be, for example a contactless card reader. Herein, the “customer information” is information on an individual customer, and may include at least customer identification information (customer ID) for confirming the identity of the individual customer. The customer information receiver 28 is not limited to the card reader, but may acquire customer information by communication with a personal digital assistant (smartphone or the like) that customers carry, or by biometrics authentication (including facial recognition). The transmitter 23 may transmit, to the management system 3, the customer information acquired through the customer information receiver 28 along with the pieces of goods information.

The basket controller 29 includes a microcomputer as a main component, and is configured to cause a processor of the computer to execute a program stored in a memory of the computer, thereby controlling each part of the circuit block 20 such as the goods information receiver 22. The program may be stored in the memory in advance, provided via a telecommunications network such as the Internet, or provided via a storage medium such as a memory card storing the program.

(2.3) Management System

A configuration of the management system 3 will be explained in detail below.

As shown in FIG. 1, the management system 3 includes the receiver 31, a sensor 32, a price data receiver 33, a list creator 34, the data transmitter 35, a communicator 36, a controller 37, an interface 38, a determining unit 39 and an inventory controller 30.

The receiver 31 is configured to receive the pieces of goods information transmitted from the transmitter 23. In the present embodiment, the receiver 31 is composed of a communication module configured to perform two-way communication with the transmitter 23 of the shopping basket 2. The receiver 31 may communicate with the transmitter 23 by optical wireless communication whose medium is radiation such as infrared radiation or visible radiation. The receiver 31 includes an external photo sensor disposed at a location on an inner peripheral surface of the recess 72 of the counter desk 7, which faces the transmitter 23 with the basket body 21 put in the predetermined location—on the bottom of the recess 72 of the counter desk 7.

The receiver 31 further includes an individual receiver 311 configured to individually receive the pieces of goods information. For example, the receiver 31 may receive the pieces of goods information all together from the shopping basket 2, and also receive the pieces of goods information one by one from the shopping basket 2 through the individual receiver 311. The individual receiver 311 is to receive goods information transmitted from the individual transmitter 231. A communication type of the individual receiver 311 may be different from a communication type of the receiver 31 when it receives the pieces of goods information all together. In the present embodiment, the individual receiver 311 will perform communication with the individual transmitter 231 by wireless communication whose medium is radio such as, e.g., Wi-Fi (trademark) or Bluetooth (trademark).

The sensor 32 is configured to sense whether or not the basket body 21 is put at the predetermined location. In the present embodiment, the predetermined location corresponds to the bottom of the recess 72 in the counter desk 7. The sensor 32 will therefore sense, whether or not the basket body 21 is put at the predetermined location, through On and Off of a push switch installed in the bottom of the recess 72 in the counter desk 7.

The price data receiver 33 is configured to acquire, from an outside of the management system 3, price data representing respective prices of the goods 9 based on the pieces of goods information. The “price data” may contain content representing the prices of the goods 9 (unit prices), and also contain content other than the prices. In the present embodiment, the price data also contain data such as, e.g., goods name (or product name), quantity, weight, consumption tax and a sum of money (checkout amount). The “outside of the management system 3” may be a device other than the management system 3, and in the present embodiment is the checkout processing system 5. The controller 37 is configured to transmit the pieces of goods information received by the receiver 31 to the checkout processing system 5 via the communicator 36. Note that details thereof will be explained in “(3.1) Basic operation”. The price data receiver 33 is to acquire, via the communicator 36, the price data transmitted as a reply (response) to the pieces of goods information from the checkout processing system 5.

The list creator 34 is configured to create a list based on the price data acquired through the price data receiver 33. Herein, the “list” is a table of information on the goods 9, which contains at least the price data. In the present embodiment, the list contains goods name, price (unit price), quantity, consumption tax and a sum of money (checkout amount). For example, the display device 65 may display the list created through the list creator 34.

The data transmitter 35 is configured to transmit display data to the shopping basket 2. As stated above, the display data are data to be displayed on the display 27 of the shopping basket 2, such as an advertisement or recommend information suitable for customers. In the present embodiment, the data transmitter 35 is composed of a communication module configured to perform two-way communication with the data receiver 26. Moreover, the one communication module configured to perform two-way communication with the shopping basket 2 is provided as not only the data transmitter 35 but also the individual receiver 311. The data transmitter 35 is therefore configured to perform communication with the data receiver 26 by wireless communication whose medium is radio such as, e.g., Wi-Fi (trademark) or Bluetooth (trademark).

The communicator 36 is a communication module configured to perform two-way communication with the checkout processing system 5. The communicator 36 may be connected with the checkout processing system 5 via, for example a local area network (LAN) cable. The management system 3 is able to be always synchronized with the checkout processing system 5 via the communicator 36. The checkout processing system 5 is able to communicate with the store server and the center server, thereby enabling the management system 3 to communicate with the store server and the center server via the checkout processing system 5.

In the present embodiment, as stated above, the checkout processing system 5 stores price data corresponding to each goods information. In addition, the checkout processing system 5, the store server or the center server may store: an information set such as advertisement information, discount information, producer information and recipe information, corresponding to each goods information; and information such as gender, age, favorite and past purchase history, corresponding to each customer information. The information set, which is not stored in the management system 3, is available to the management system 3 as a result of the management system 3 communicating with the checkout processing system 5, the store server or the center server.

The controller 37 includes a computer as a main component, and is configured to cause a processor of the computer to execute a program stored in a memory of the computer, thereby controlling each part of the management system 3 such as the receiver 31. The program may be stored in the memory in advance, provided via a telecommunications network such as the Internet, or provided via a storage medium such as a memory card storing the program.

The interface 38 is an interface array configured to connect the management system 3 to components of the shopping assistance system 1 other than the shopping basket 2. The interface 38 is connected to the packing machine 4, the operation terminal 61, the image capturing device 62, the measuring device 63, the supply unit 64, the display device 65 and the voice input device 66. The interface 38 includes different types of interfaces depending on connection targets, and is connected to the packing machine 4 and the supply unit 64 via, for example Ethernet (trademark) for control automation technology (EtherCAT (trademark)). The interface 38 is also connected to the measuring device 63 via, for example RS-232C.

The controller 37 may be configured to receive a voice signal from the voice input device 66 via the interface 38 to apply speech recognition and semantic analysis to the voice signal. Thus, a voice input function is available to the management system 3 as a user interface.

The determining unit 39 is configured to calculate total weight of the goods 9 from at least one piece of weight data corresponding to the pieces of the goods information. The determining unit 39 is further configured to compare the total weight with a measurement value by the measuring device 63. Herein, the “weight data” are data representing the weight of at least one item of goods (or at least one product) 9, and stored in the outside of the management system 3 (in the embodiment, the checkout processing system 5) with the weight data associated with corresponding goods information. In the present embodiment, the price data acquired from the checkout processing system 5 through the price data receiver 33 contain the weight data representing the weight of one item of goods (or product) 9. An operation of the determining unit 39 will be explained in detail in in “(3.4) Weight determining process”.

The inventory controller 30 is configured to monitor inventory quantity of the one or more types of specific goods (or products) based on a sales history of the one or more types of specific goods. In the present embodiment, the specific goods are, for example goods in a merchandising equipment or a food cart installed around the counter desk 7, such as Oden (fishcake and vegetable stew), Karaage (deep-fried chicken) and Chinese steamed bun. The inventory controller 30 may synchronize with the checkout processing system 5, thereby managing the sales history of the specific goods.

The controller 37 also has a function as a display controller 371 configured to control the display device 65. The display controller 371 may transmit display data to the display device 65, thereby causing the display device 65 to display on-screen information such as arbitrary information. In the present embodiment, the display controller 371 is configured to cause the display device 65 to display at least an on-screen menu. Herein, the “on-screen menu” allows selection of the one or more types of specific goods. The display controller 371 may vary contents of on-screen menu based on a monitoring result by the inventory controller. Respective operations of the inventory controller 30 and the display controller 371 will be explained in detail in “(3.5) Specific goods selling process”.

(2.4) Packing Machine

A configuration of the packing machine 4 will be explained in detail below.

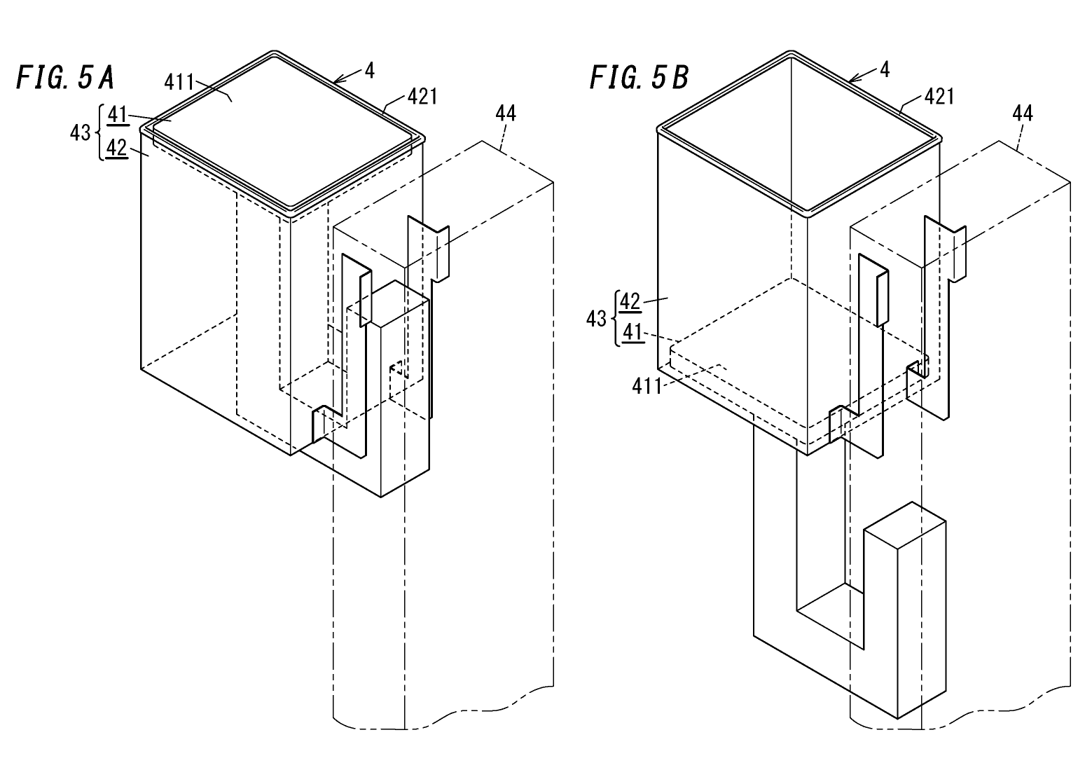

A shown FIGS. 5A and 5B, the packing machine 4 includes a body mechanism 43 and a driver 44. The body mechanism 43 includes a support 71 and a guide 42. Note that in FIGS. 5A and 5B part of the driver 44 is depicted by an imaginary line (long dashed double-short dashed line).

The support 41 is formed with a placement surface 411 that allows goods 9 to be placed on. The guide 42 is disposed around the support 41 along outer peripheral edges of the placement surface 411. The driver 44 is configured to move at least one of the support 41 and the guide 42 to change a state of the body mechanism 43 from a first state shown in FIG. 5A to a second state shown in FIG. 5B. Herein, the “state of the body mechanism 43” represents a location of the support 41 relative to the guide 42. A location of the support 41 relative to the guide 42 in the second state is lower than that in the first state.

As shown in FIG. 6A, the body mechanism 43 is configured to support a bottom 82 of the bag 8 having an opening 81 at a top thereof by the placement surface 411 in a state where the bag 8 is upside down and covers the support 41 and the guide 42 from above. Herein, the “support” means to support from below. That is, when goods 9 are placed on the placement surface 411 from above the bottom 82, the bottom 82 is pressed onto the placement surface 411 by the weight of the goods 9, so that the bottom 82 is supported by the placement surface 411. As shown in FIGS. 6B and 6C, when the state of the body mechanism 43 changes from the first state to the second state, the body mechanism 43 raises a lateral periphery 83, continuous with the bottom 82, of the bag 8 upward from the bottom 82 by the guide 42 to put the goods 9 into the bag 8.

The packing machine 4 includes a back feeder 45 configured to feed a bag 8 to the body mechanism 43 (see FIG. 1). The back feeder 45 is a mechanism configured to cover the body mechanism 43 in the first state with a bag 8 that is upside down. The back feeder 45 is driven by the driver 44.

Specifically, the support 41 is flat rectangular in shape. An upper surface of the support 41 corresponds to the placement surface 411 that allows goods 9 to be placed on. The support 41 is made of, for example synthetic resin. The guide 42 is in the shape of a hollow cylinder, and of an upper surface and a lower surface thereof, at least the upper surface opens. In the present embodiment, the guide 42 is in the shape of a square tube, and both the upper and lower surfaces open. The guide 42 is made of, for example synthetic resin. The shape of inner peripheral edges of an upper end face 421 of the guide 42 is analogous to the shape of outer peripheral edges of the placement surface 411. The driver 44 is configured to move downward only the support 41 of the body mechanism 43, thereby varying the state of the body mechanism 43 from the first state to the second state. That is, the support 41 is configured to move in the vertical direction inside the hollow cylindrical guide 42 fixed in place.

As shown in FIG. 6A, when the body mechanism 43 is in the first state, the placement surface 41 forms part of the bottom of the recess 72 in the counter desk 7 that allows the basket body 21 to be put in. Accordingly, when the lower opening 212 of the basket body 21 is opened in a state where the basket body 21 in which goods 9 are put is placed at the predetermined location (on the bottom of the recess 72 in the counter desk 7), the goods 9 are exited on the placement surface 411 from the basket body 21. Thus, the packing machine 4 moves the pair of pins 73 protruding from the bottom of the recess 72 with the basket body 21 placed at the predetermined location, thereby moving the pair of base plates 214 from the closing position to the opening position (see FIGS. 4A to 4C) to open the lower opening 212 of the basket body 21. This enables the packing machine 4 to move the goods 9 inside the basket body 21 all together on the placement surface 411.

With the configuration, the goods 9 are exited from the basket body 21 with the body mechanism 43 being in the first state, and the goods 9 are then placed on the placement surface 411 through the bag 8. The bottom 82 of the bag 8 is sandwiched between the support 41 and the goods 9. In this example, the bottom 82 is held on the placement surface 411 by the weight of the goods 9. From this state (first state), the support 41 moves downward relative to the guide 42, so that the bag 8 is gradually drawn into an inside of the guide 42 as shown in FIG. 6B. In this case, the lateral periphery 83 continuous with the bottom 82 of the bag 8 is drawn into the inside of the guide 42 while being squeezed by the upper end face 421 of the guide 42. Thus, the lateral periphery 83 of the bag 8 is raised upward from outer peripheral edges of the bottom 82 by the guide 42 around the support 41.

Subsequently, the state of the body mechanism 43 changes to the second state, and the bag is then turned over from the state shown in FIG. 6A within the space surrounded by the guide 42, so that the goods 9 are put into the bag 8. In this case, the lateral periphery 83 is raised along inner peripheral surfaces of the guide 42. The bag 8 becomes a state where not only the lateral periphery 83 but also carrying handles 84 thereof are raised. That is, the support 41 moves relative to the guide 42, and thereby the goods 9 on the placement surface 411 are put all together into the bag 8.

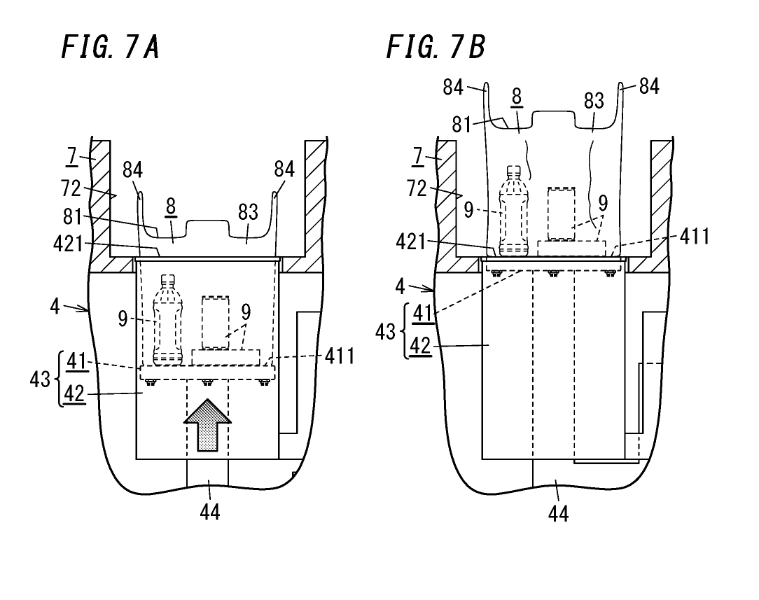

The packing machine 4 is configured to drive the body mechanism 43 through the driver 44 to change the state of the body mechanism 43 from the second state to the first state, thereby causing the bag 8 to exit from the space surrounded by the guide 42. That is, the bag 8 on the placement surface 411 protrudes upward from an upper opening of the guide 42 while the support 41 is moving upward as shown in FIG. 7A. The support 41 further moves upward, and thereby the bag 8 is completely exited from the space surrounded by the guide 42 as shown in FIG. 7B. At this moment, the bag 8 maintains a standing posture including the carrying handles 84. Thus, it is changed to the state shown in FIG. 7B, and consequently the packing machine 4 finishes the packing process of transferring the goods 9 to the bag 8. The packing machine 4 finishing the packing process allows customers to receive the bug 8 that the goods 8 are put into.

### (3) Operation

An operation of the shopping assistance system 1 according to the present embodiment will be explained below.

(3.1) Basic Operation

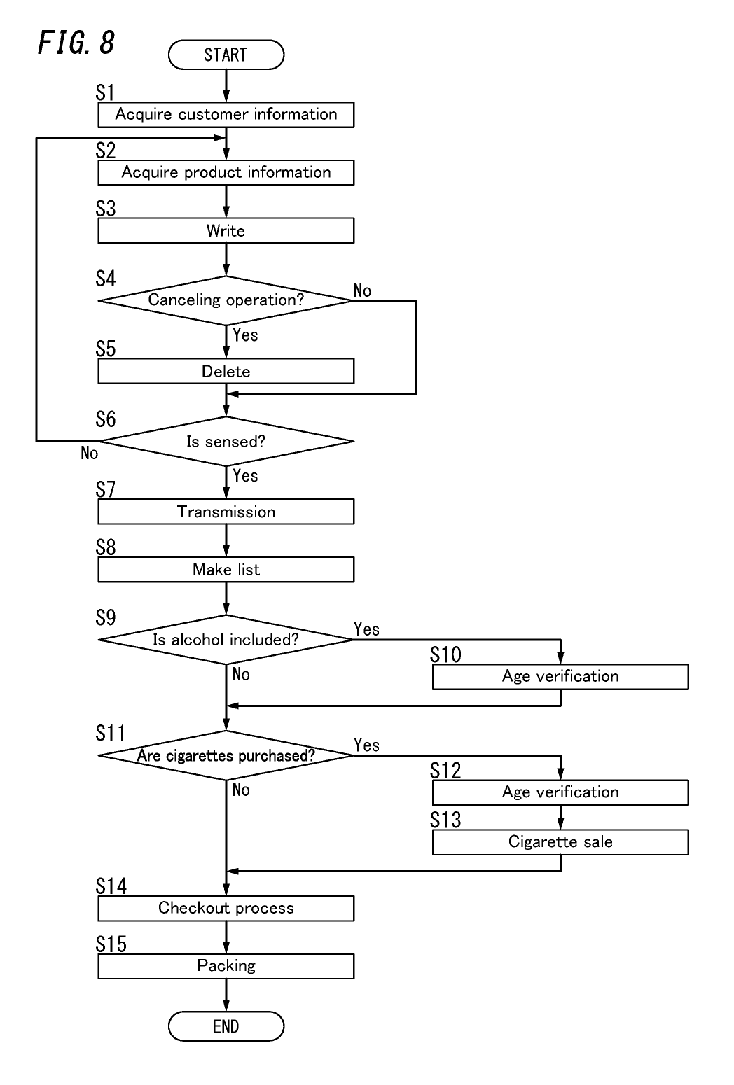

A basic operation of the shopping assistance system 1 from customer visit to the store until packing the goods 9 is completed will be explained with reference to the flow chart of FIG. 8.

Before customer visit to the store, the shopping baskets 2 are placed in a predetermined basket area with the shopping baskets 2 initialized. In the initialized shopping baskets 2, the memories 24 thereof are reset. That is, the memories 24 store no goods information. In addition, respective batteries of the shopping baskets 2 placed in the basket area are charged as needed.

Customers visiting the store first take a shopping basket 2 from the basket area. At this moment, the basket controller 29 controls the customer information receiver 28 to acquire customer information from a card owned by each customer (e.g., member's card) (step S1). Customers carrying the shopping basket 2 subsequently move in the store and put goods 9 that they desire to purchase one by one in the basket body 21. At this moment, the basket controller 29 controls the goods information receiver 22 to optically read a barcode of each item of goods (or each product) 9 to be put in the basket body 21 through the goods information receiver 22 to acquire respective goods information on the goods 9 (step S2). The basket controller 29 stores the pieces of goods information acquired through the goods information receiver 22 in the memory 24 (step S3).

If no cancel operation is performed (step S4: No), the basket controller 29 proceeds to step S6 and the sensor 32 senses whether or not the basket body 21 is placed on the predetermined location. If a cancel operation is performed by customers (step S4: Yes), the basket controller 29 deletes the goods information stored in the memory 24 through the canceller 25 (step S5), and then proceeds to step S6. If the sensor 32 does not sense that the basket body 21 is placed on the predetermined location (SG: No), the basket controller 29 returns to step S2 to repeat the processes of S2 to S6.

Customers subsequently put, at the predetermined location (on the bottom of the recess 72 in the counter desk 7), the shopping basket 2 that all the goods 9 they desire to purchase are put in. In this state, the pieces of goods information on the goods 9 that customers desire to purchase is stored in the memory 24. At this moment, the sensor 32 senses that the basket body 21 is placed on the predetermined location (step S6: Yes). The controller 37 receives a sensed result by the sensor 32 and then transmits a trigger signal from the receiver 31 to the transmitter 23. When the transmitter 23 receives the trigger signal, the basket controller 29 transmits the pieces of goods information stored in the memory 24 from the transmitter 23 to the receiver 31 (step S7). That is, when the sensor 32 senses that the basket body 21 is placed on the predetermined location, the transmitter 23 transmits the pieces of goods information. After transmitting the pieces of goods information, the transmitter 23 repeats the transmission of the pieces of goods information during a retransmission period as an upper limit till receiving an acknowledgement (ACK) from the receiver 31.

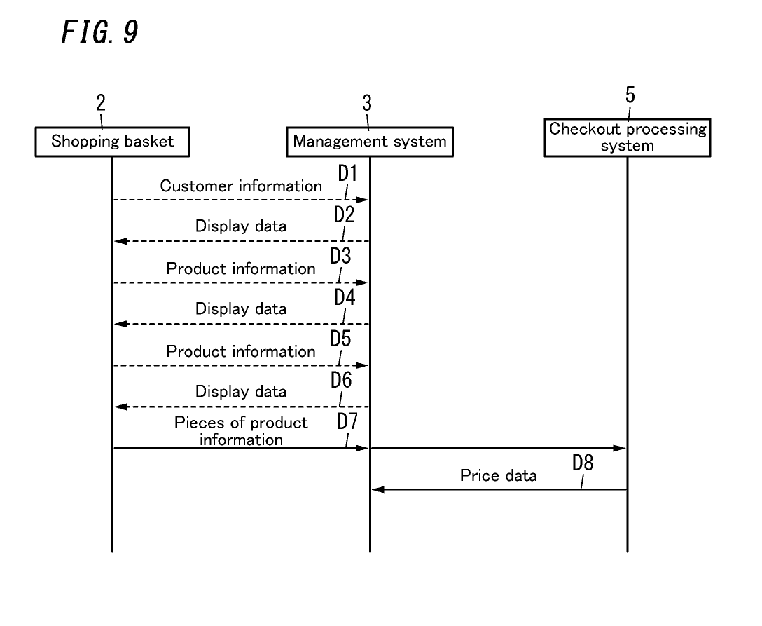

When the receiver 31 receives the pieces of goods information, the controller 37 then transmits (transfers) the pieces of goods information received through the receiver 31 from the communicator 36 to the checkout processing system 5. The price data receiver 33 acquires, through the communicator 36, price data transmitted as a reply (response) to the pieces of goods information from the checkout processing system 5. Specifically, as shown in FIG. 9, when the pieces of goods information “D7” is transmitted from the shopping basket 2 to the management system 3, the management system 3 transfers, to the checkout processing system 5, the pieces of goods information “D7” as it is. Thus, the price data “D8” corresponding to the pieces of goods information “D7” are returned from the checkout processing system 5 to the management system 3. The list creator 34 subsequently creates a list containing goods name (or product name), price (unit price), quantity, consumption tax and a sum of money (checkout amount) based on the price data acquired through the price data receiver 33 (step S8). The controller 37 causes the display device 65 to display the list created by the list creator 34.

At this moment, the controller 37 judges whether or not one or more specific goods requiring permission of clerks to purchase are contained in the list. As an example of the specific goods, the present embodiment includes alcohol goods (hereinafter simply referred to as “alcohol”). Herein, the controller 37 judges whether or not alcohol is included in the goods put in the basket body 21 based on the list (step S9). When alcohol is contained in the list (step 9: Yes), the controller 37 proceeds to an age verification process (step S10). The age verification process will be explained in detail in “(3.3) Age verification process”.

When the age verification process (step S10) finishes or the list contains no alcohol (step S9: No), the controller 37 causes the display device 65 to display on-screen verification for verifying whether or not cigarettes are purchased. In the on-screen verification, when customers select purchasing the cigarettes (step S11: Yes), the controller 37 proceeds to a cigarette selling process (step S13) via an age verification process (step S12). However, when the list contains alcohol (step S9: Yes) and the age verification process (step S10) has been already performed, the controller 37 skips the age verification process at step S12 and directly proceeds to step S13 from step S11.

In the cigarette selling process (step S13), the controller 37 causes the display device 65 to display an on-screen cigarette menu that allows customers to select one of cigarette brands. The on-screen cigarette menu has hierarchic structure, and allows refinement by, for example, brand, price range, or tar and nicotine amount. When the transmitter 23 transmits customer information acquired through the customer information receiver 28 to the management system 3, the controller 37 may cause the display device 65 to display an on-screen cigarette menu refined by the brand or the like based on the customer information. In the on-screen cigarette menu, when cigarettes are selected as particular cigarettes, the controller 37 transmits goods information on the particular cigarettes to the supply unit 64 and the checkout processing system 5. The supply unit 64 selects the particular cigarettes from different types of cigarettes stored in the supply unit 64 to dispense one or more packs of the particular cigarettes to an outlet 641 thereof (see FIG. 2). This configuration enables customers to receive the cigarettes from the outlet 641. The controller 37 acquires price data about the cigarettes from the checkout processing system 5 and then adds the price data to the list created at step S8.

When the cigarette selling process (step S13) finishes or customers do not select purchasing any cigarettes (step S11: No), the controller 37 then proceeds to a checkout process (step S14). At this moment, the controller 37 causes the display device 65 to display on-screen checkout confirmation containing the list. When “Start checkout” in the on-screen checkout confirmation is selected, the controller 37 causes the checkout processing system 5 to start a checkout process. In the checkout process, the management system 3 functions as a simple user interface, while the payment process is performed through the checkout processing system 5.

After the checkout process is started, the controller 37 causes the packing machine 4 to perform the packing (S15). That is, after causing the checkout processing system 5 to start the checkout process, the controller 37 transmits a control signal for starting a packing process to the packing machine 4. The packing machine 4 accordingly transfers the goods 9 from the basket body 21 to a bag 8 while the checkout process of the goods is performed. Specifically, the packing machine 4 opens the lower opening 212 of the basket body 21 to allow the goods 9 to exit from the basket body 21 onto the placement surface 411, thereby putting the goods 9 on the placement surface 411 all together into the bag 8. Note that preferably after the checkout process is completed, the customer is allowed to receive the bag 8, with the packing process by the packing machine 4 completed, into which the goods 9 are put (see FIG. 7B). That is, when notified of the completion of the checkout process from the checkout processing system 5, the controller 37 then transmits a control signal for making the packing process finish to the packing machine 4.

Here, the packing machine 4 may select a bag 8 for the goods 9 to be putted into from different types of bags based on the pieces of goods information. Specifically, when the different types of bags 8 have, for example, different shapes, sizes and color, the controller 37 may select one type of bag 8 from the different types of bags 8 based on the pieces of goods information. The controller 37 then transmits a control signal containing information designating the type of the selected bag 8 to the packing machine 4. The packing machine 4 accordingly selects a bag 8 having the type designated by the controller 37 from the different types of bags 8, and enables the back feeder 45 to cover the body mechanism 43 with the bag.

For example, the shopping assistance system 1 may select whether or not cigarettes are purchased, and select the cigarettes in the cigarette selling process, through input against the display device 65 as a touch panel display or through voice input. In this example, the shopping assistance system 1 including the voice input device 66 enables customers to provide the shopping assistance system 1 with voice input.

As explained above, the basis operation of the shopping assistance system 1 enables customers to finish purchasing the goods 9 by a series of processes of choosing the goods 9 in the store to put them in the shopping basket 2, performing the checkout and then packing the goods 9 all together. In short, when customers put the goods 9 in the shopping basket 2, the pieces of goods information on the goods 9 is stored all together in the memory 24 of the shopping basket 2. It is therefore possible to provide the pieces of goods information on the goods 9 all together to the management system 3 to utilize them for the checkout process without separating the goods 9 put in the shopping basket 2, and transfer the goods 9 all together into the bag 8.

(3.2) Display Function of Shopping Basket

An display operation by the display 27 of the shopping basket 2 in the shopping assistance system 1 will be explained with reference to FIG. 9. In the present embodiment, the display 27 is configured to display two types of information.

First type of information is information on a customer to put goods 9 in a basket body 21. Examples of the information include recommendation information suitable for the customer and the like—namely, information about respective on-sale dates of goods regularly purchased by the customer, an advertisement for new goods of goods purchased by the customer in the past, an advertisement for limited seasonal goods, and discount information on goods purchased by the customer in the past. In this example, the display 27 performs display based on the display data relevant to the customer information acquired through the customer information receiver 28. Specifically, when the customer information receiver 28 in the shopping basket 2 acquires the customer information, the transmitter 23 transmits the customer information “D1” to the receiver 31 as shown in FIG. 9. When receiving the customer information “D1”, the management system 3 performs search for customer's gender, age, favorite and past purchase history based on the customer information to create display data relevant to the customer information. When the data transmitter 35 of the management system 3 transmits the display data “D2” to the data receiver 26 of the shopping basket 2, the display 27 then displays information relevant to the customer.

Second type of information is information relevant to one or more goods 9 put in the basket body 21. Examples of the information include an advertisement for new goods of the goods 9, an advertisement for limited seasonal goods, discount information on the goods 9, producer information of the goods 9, and recipe information relevant to one or more goods 9 if they are food. Here, the data transmitter 35 transmits display data relevant to goods information, received through the individual receiver 311, of pieces of goods information. Specifically, whenever the goods information receiver 22 in the shopping basket 2 acquires goods information, the individual transmitter 231 then transmits the goods information “D3” to the individual receiver 311. When receiving the goods information “D3”, the management system 3 then performs, based on the goods information, search for information relevant to the item of goods (or the product) 9 to create display data relevant to the goods information. When the data transmitter 35 of the management system 3 transmits display data “D4” to the data receiver 26 of the shopping basket 2, the display 27 then displays information relevant to the item of goods 9. Similarly, when the goods information receiver 22 newly acquires goods information, the individual transmitter 231 then transmits goods information “D5” to the individual receiver 311, and the data transmitter 35 transmits display data “D6” relevant thereto to the data receiver 26.

The display 27 may display information relevant to the customer to put the goods 9 in the basket body 21 and the goods 9 put in the basket body 21. In this example, the data transmitter 35 transmits display data relevant to both the customer information and the pieces of goods information.

(3.3) Age Verification Process

The age verification process (step S10 or S12 in FIG. 8) will be next explained.

When judging that the list contains alcohol at step S9 in FIG. 8, namely when goods 9 include one or more specific goods that require permission of clerks to purchase (in the present embodiment, alcohol). the management system 3 then transmits a request signal to the operation terminal 61. Similarly, when the purchase of cigarettes is selected, namely when one or more specific goods that require permission of clerks to purchase (in the present embodiment, cigarettes) are purchased along with the goods 9, the management system 3 then transmits a request signal to the operation terminal 61. In any case, when receiving a predetermined operation after receiving the request signal, the operation terminal 61 then transmits a permission signal to the management system 3.

In short, when the customer purchases one or more specific goods (in the present embodiment, alcohol or cigarettes), the management system 3 then transmits a request signal for requesting clerks to verify customer's age to the operation terminal 61. When performing the age verification to permit the purchase, clerks perform a predetermined operation through the operation terminal 61, thereby causing the operation terminal 61 to transmit a permission signal for permitting the purchase of the specific goods to the management system 3. On the other hand, when performing the age verification not to permit the purchase, clerks perform a predetermined operation through the operation terminal 61, thereby causing the operation terminal 61 to transmit a non-permission signal for not permitting the purchase of the specific goods to the management system 3.

Until receiving the permission signal from the operation terminal 61, the management system 3 prohibits the checkout processing system 5 from staring a checkout process of the specific goods. When receiving the permission signal from the operation terminal 61, the management system 3 then causes the checkout processing system 5 to start the checkout process of the specific goods. In short, when customers purchase the specific goods (in the present embodiment, alcohol or cigarettes), the checkout processing system 5 is in a stand-by state, in which the checkout process is not started, until the management system 3 receives the permission signal from the operation terminal 61. When receiving the non-permission signal from the operation terminal 61, the management system 3 then causes the display device 65 to display a message saying “Age verification failed” or the like, without causing the checkout processing system 5 to start the checkout process.

In the present embodiment, the management system 3 transmits a request signal containing image data captured by the image capturing device 62 to the operation terminal 61. When receiving the request signal, the operation terminal 61 then performs display through the image display 611 based on the image data contained in the request signal. In this example, the image capturing device 62 captures an image of a customer standing in front of the counter desk 7, including his or her face. The image display 611 of the operation terminal 61 is accordingly to display the customer's image. This enables clerks to perform age verification based on the customer's image displayed on the image display 611.

(3.4) Weight Determining Process

The weight determining process in which the management system 3 judges, based on weight, whether or not the goods 9 put in the basket body 21 matches targets of the checkout process will be next explained. Although the weight determining process may be performed in timing between step S7 and step S14 in FIG. 8, in the present embodiment it is performed, for example when the list is created at step S8 in FIG. 8. In this example, two processes of the list creation and the weight determining process are performed at step S8 in FIG. 8.

Herein, the determining unit 39 in the management system 3 calculates total weight of the goods 9 from at least one piece of weight data corresponding to the pieces of the goods information. In this case, the determining unit 39 calculates the total weight of the goods 9 based on the price data acquired through the price data receiver 33 from the checkout processing system 5 as a reply to the pieces of goods information. The determining unit 39 compares the weight measured by the measuring device 63 (a measurement value of the measuring device 63) with the calculated total weight of the goods 9.

In this case, when the total weight is out of a prescribed range, the determining unit 39 prohibits the checkout processing system 5 from staring the checkout process of the goods 9. When the total weight is in the prescribed range, the management system 3 causes the checkout processing system 5 to start the checkout process of the goods 9. When the weight determining process is performed at step S8 in FIG. 8, the controller 37 stops the process at step S9 in FIG. 8 until the total weight becomes in the prescribed range. As a result, the checkout process of the goods 9 is not started. Here, the “prescribed range” is a numeral range based on the measurement value by the measuring device 63 and for example, includes a predetermined margin centered on a value obtained by subtracting the weight of the shopping basket 2 from the measurement value by the measuring device 63. That is, the measurement value by the measuring device 63 is the weight of the shopping basket 2 with the goods 9 put in the basket body 21, and therefore the determining unit 39 compares the value, obtained by subtracting the weight of the shopping basket 2 from the measurement value by the measuring device 63, with the total weight calculated based on the pieces of goods information.

Employing the weight determining process enables the management system 3 to judge whether or not the goods 9 actually put in the basket body 21 match checkout process targets. It is therefore possible to prevent the checkout processing system 5 from performing the checkout process based on wrong pieces of goods information, for example when the goods information receiver 22 fails goods information reading.

(3.5) Specific Goods Selling Process

The specific goods selling process executed by the management system 3 with respect to one or more types of specific goods to be purchased will be next explained. Although the specific goods selling process may be performed in timing between step S7 and step S14 in FIG. 8, in the present embodiment it is performed, for example just before step S14 in FIG. 8. In this example, when the cigarette selling process (step S13) finishes or customers do not select purchasing any cigarettes (step S11: No), the specific goods selling process is then started.

When starting the specific goods selling process, the controller 37 then causes the display device 65 to display an on-screen confirmation that allows customers to select whether to purchase one or more specific goods or not. When purchasing the specific goods is selected in the on-screen confirmation, the controller 37 then proceeds to the specific goods selling process.

In the specific goods selling process, the display controller 371 in the controller 37 causes the display device 65 to display an on-screen menu that allows customers to select one or more types of specific goods. The on-screen menu has hierarchic structure, and allows refinement by, for example, type (Oden, fried food or the like) or price range. When one or more specific goods are selected in the on-screen confirmation, the controller 37 then transmits respective goods information of the one or more specific goods to the checkout processing system 5. Clerks may provide customers with the specific goods, or customers may take the specific goods. The controller 37 also acquires, from the checkout processing system 5, price data of the specific goods to be added to the list created at step S8.

Here, the inventory controller 30 always monitors respective stock quantities of the one or more types of specific goods. That is, the inventory controller 30 always monitors current respective stock quantities of the specific goods in the merchandising equipment based on respective quantities of one or more types of specific goods added (replenished) to the merchandising equipment by clerks and a sales history of every specific item of goods (or specific product). For example, clerks may enter, through the operation terminal 61, the respective quantities of the specific goods added to the merchandising equipment.

The display controller 371 varies, according to a monitoring result by the inventory controller 30, contents of the on-screen menu displayed by the display device 65 in the specific goods selling process. For example, the display controller 371 excludes one or more types of specific goods out of stock (stock quantity of 0) from the on-screen menu, thereby avoiding a purchase operation being made wrongly with respect to such specific goods out of stock. Note that the display controller 371 may add respective stock quantities of specific goods monitored by the inventory controller 30 to the on-screen menu.

### (4) Modified Examples

The abovementioned embodiment is merely an example of the present invention. The present invention is not limited to the embodiment, but various modifications are possible in light of general arrangement and the like and may be made regardless of the configurations without departing from the scope of technical ideas according to the present invention.

### (4.1) First Modified Example

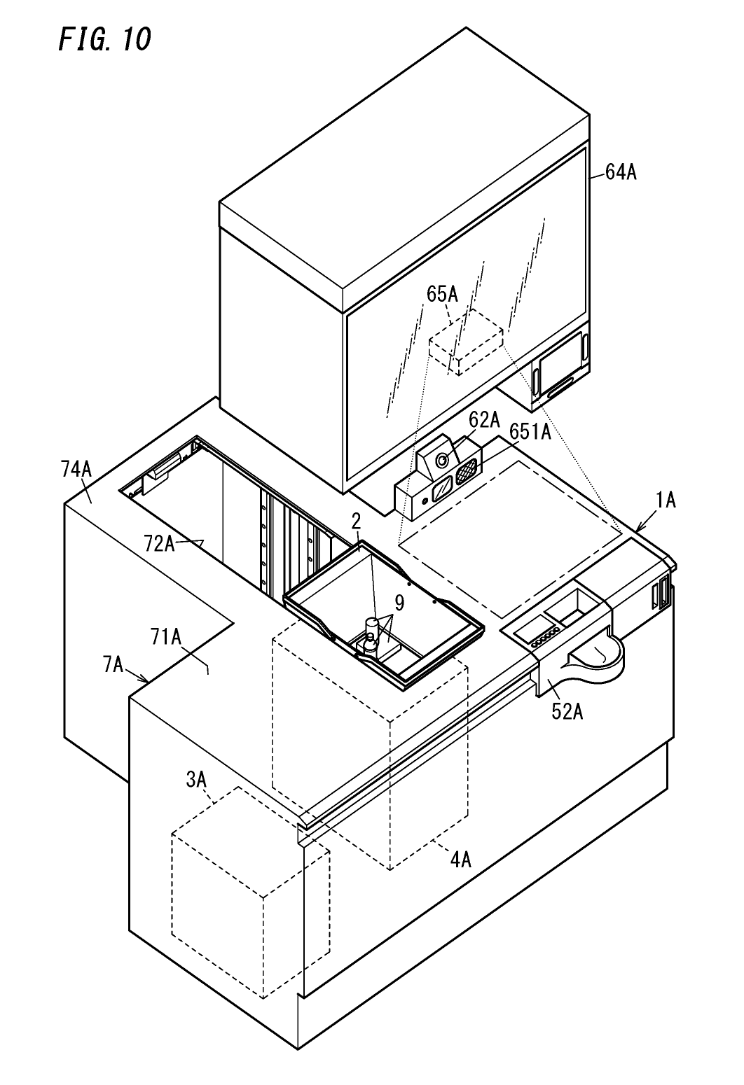

As shown in FIG. 10, a shopping assistance system 1A according to the first modified example of the abovementioned embodiment includes a supply unit 64A, an image capturing device 62A, a display device 65A and the like whose configurations are different from those of the embodiment. Identical constituent elements to those of the embodiment are allocated identical reference numerals, and description thereof is also omitted as appropriate.

In the shopping assistance system 1A according to the first modified example, the display device 65A is configured to, for example project an image onto a target by projection mapping techniques, and not a touch panel display. In the example of FIG. 10, the supply unit 64A is suspended from a ceiling to be provided above a counter desk 7A. The display device 65A is fixed to a lower surface of the supply unit 64A. Herein, the display device 65A projects an image onto a right region of a recess 72A as viewed from a front side of the counter desk 7A. That is, the right region of the recess 72A in an upper surface 71A of the counter desk 7A serves as a screen of the display device 65A.

The image capturing device 62A is on the upper surface 71A of the counter desk 7A and disposed behind the screen as viewed from the front side of the counter desk 7A. For example, the image capturing device 62A is provided integrally with an input device that allows customers to enter their operation by: a voice input device (microphone) configured to pick up customers' voice; and gesture detection and the like. Thus, along with the input device, the display device 65A constitutes what is called an interactive projection system (IPS) that allows customers to enter their gesture into. The image capturing device 62A is further provided integrally with a voice output device 651A.

Note that the target onto which the image is projected is not limited to a plane such as the upper surface 71A of the counter desk 7A, but may be an object having a three-dimensional shape. For example, when the target is a mannequin simulating human upper body, the projection mapping techniques of the display device 65A enables making the object look like various people.

The counter desk 7A is also provided with a management system 3A and a packing machine 4A. A body of a checkout processing system 5 (see FIG. 2) is built in the counter desk 7A. A cash unit 52A is provided in a state where it is exposed from the upper surface 71A of the counter desk 7A. A collecting machine 74A configured to collect shopping baskets 2 is disposed behind the recess 72A as viewed from the front side of the counter desk 7A.

### (4.2) Second Modified Example

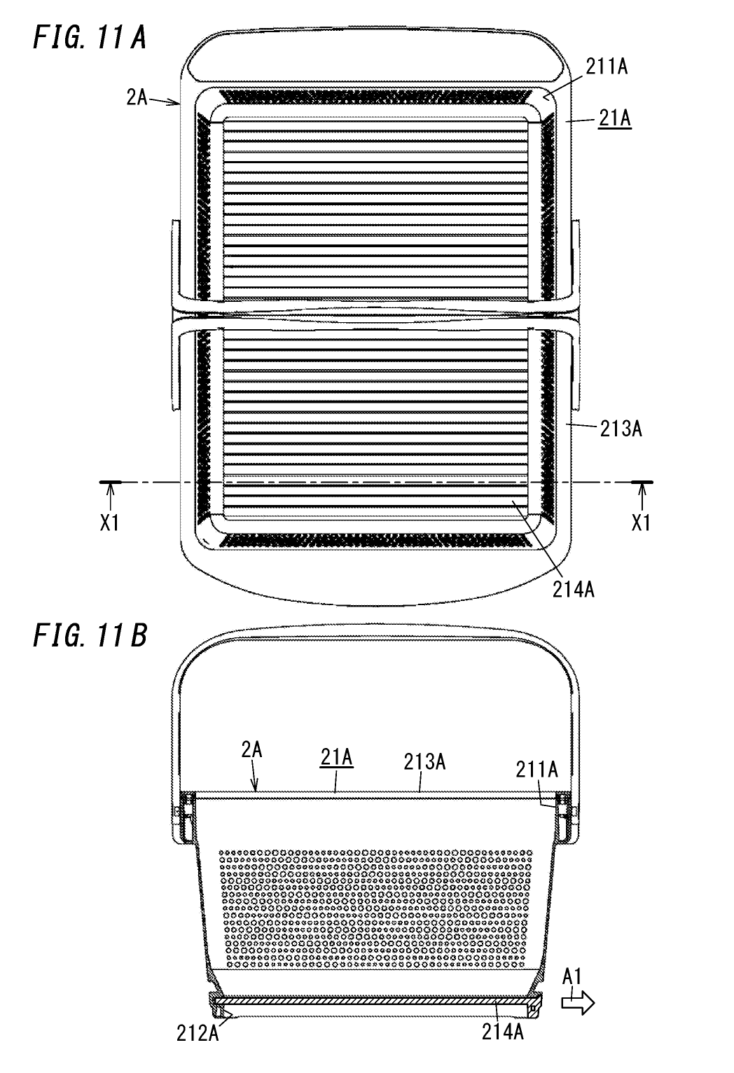

As shown in FIGS. 11A and 11B, a shopping assistance system 1 according to the second modified example of the abovementioned embodiment includes a shopping basket 2A whose configuration is different from that in the embodiment. FIG. 11B is a sectional view taken along an X1-X1 line in FIG. 11A. Identical constituent elements to those of the embodiment are allocated identical reference numerals, and description thereof is also omitted as appropriate.

Herein, a basket body 21A of the shopping basket 2A according to the second modified example includes a body 213A and a base plate 214A.

The body 213A is formed with an upper opening 211A and a lower opening 212A, and allows goods 9 (see FIG. 2) to be put in. The base plate 214A is attached to the body 213A to allow opening and closing of the lower opening 212A.

In the present modified example, the base plate 214A is in the shape of a single board. The base plate 214A is held by the body 213A with the base plate 214A allowed to slide in a widthwise direction of the lower opening 212A. Specifically, as shown in FIGS. 11A and 11B, when the base plate 214A is in a closing position, the lower opening 212A of the body 213A is closed by the base plate 214A. From this state, the base plate 214A slides toward a direction depicted by an arrow A1 in FIG. 11B along the widthwise direction of the lower opening 212A and then moves to an opening position, thereby opening the lower opening 212A. When the base plate 214A is in the opening position, the base plate 214A protrudes from a side wall of the body 213A toward the side of the body 213A.

In the present modified example, pins for moving the base plate 214A protrude from a bottom of a recess 72 in a counter desk 7 like the abovementioned embodiment. A packing machine 4 moves the pins, thereby moving the base plate 214A between the closing position and the opening position.

Modified examples other than the first and second modified examples will be recited below.

The memory 24 of the shopping basket 2 is not an essential component of the shopping assistance system 1, but may be appropriately omitted. In this example, whenever the goods information receiver 22 acquires goods information, the transmitter 23 may transmit the goods information to the management system 3, thereby storing pieces of goods information in the management system 3.

The sensor 32 of the management system 3 is not an essential component of the shopping assistance system 1, but may be appropriately omitted.

The canceller 25 of the shopping basket 2 is not an essential component of the shopping assistance system 1, but may be appropriately omitted.

The price data receiver 33 and the list creator 34 of the management system 3 are not essential components of the shopping assistance system 1, but may be appropriately omitted.

The configuration in which after the checkout process is completed, the packing machine 4 finishes the packing process of transferring goods 9 from the basket body 21 to the container (bag 8) is not an essential configuration of the shopping assistance system 1. The packing machine 4 may finish the packing process before the checkout process is completed. In this case there is an advantage that enables further reduction in shopping time.

The configuration in which the packing machine 4 selects a container (bag 8) for goods 9 to be putted into from different types of containers (bags 8) is not an essential configuration of the shopping assistance system 1. Only one type of container (bag 8) may be employed.

The configuration in which the packing machine 4 includes: the body mechanism 43 including the support 41 and the guide 42; and the driver 44 is not an essential configuration of the shopping assistance system 1, but may be appropriately modified. For example, the driver 44 may be configured to move not the support 41 but the guide 42, thereby varying the state of the body mechanism 43 from the first state to the second state.

The configuration in which the basket body 21 includes the body 213 and the base plate 214 is not an essential configuration of the shopping assistance system 1, but may be appropriately modified. For example, the basket body 21 may be configured so that the whole of the basket body 21 is tilted, thereby allowing the goods 9 in the basket body 21 to exit therefrom. Only one single base plate 214 may be provided. In this case, the single base plate 214 slides along the lower surface of the body 213, thereby moving between the closing position and the opening position.

The data transmitter 35 of the management system 3, and the data receiver 26 and the display 27 of the shopping basket 2 are not essential components of the shopping assistance system 1, but may be appropriately omitted.

The individual transmitter 231 of the shopping basket 2, and the individual receiver 311 of the management system 3 are not essential components of the shopping assistance system 1, but may be appropriately omitted.

The customer information receiver 28 of the shopping basket 2 is not an essential component of the shopping assistance system 1, but may be appropriately omitted.

The operation terminal 61 is not an essential component of the shopping assistance system 1, but may be appropriately omitted. The configuration in which when one or more specific goods requiring permission of clerks to purchase are selected, a request signal is then transmitted to the operation terminal 61 is not an essential configuration of the shopping assistance system 1, but may be appropriately omitted.

The image capturing device 62 is not an essential component of the shopping assistance system 1, but may be appropriately omitted. The image display 611 of the operation terminal 61 is not an essential component of the shopping assistance system 1, but may be appropriately omitted. The configuration in which the management system 3 transmits a request signal containing image data captured by the image capturing device 62 is not an essential configuration of the shopping assistance system 1, but may be appropriately omitted. In this case, when the request signal is transmitted to the operation terminal 61, clerks may perform the age verification process and the like by directly confirming customer's face.

The configuration in which the checkout processing system 5 is prohibited from staring the checkout process of one or more specific goods until the management system 3 receives a permission signal is not an essential configuration of the shopping assistance system 1, but may be appropriately omitted.

The measuring device 63 is not an essential component of the shopping assistance system 1, but may be appropriately omitted. The determining unit 39 of the management system 3 is not an essential component of the shopping assistance system 1, but may be appropriately omitted. For example, the management system 3 may judge whether or not goods 9 actually put in the basket body 21 match goods 9 acquired from pieces of goods information through the goods information receiver 22, in place of the determining unit 39 or in addition to the determining unit 39. In this case, the management system 3 may apply image recognition processing to an image acquired from an image sensor configured to photograph an inside of the basket body 21, thereby specifying the goods 9 actually put in the basket body 21.

The configuration in which the checkout processing system 5 is prohibited from starting the checkout process of the goods 9 when the total weight is out of the prescribed range based on the measurement value by the measuring device 63 is not an essential configuration of the shopping assistance system 1, but may be appropriately omitted.

The configuration in which the management system 3 is configured to communicate with the checkout processing system 5 is not an essential configuration of the shopping assistance system 1, but may needn't communicate with the checkout processing system 5. For example, the management system 3 may have a function of performing the checkout process of the goods 9 based on the pieces of goods information.

The display controller 371 and the inventory controller 30 of the management system 3 are not essential components of the shopping assistance system 1, but may be appropriately omitted.

The operation terminal 61 is not limited to the configuration it is placed in position (counter desk 7) as stated in the abovementioned embodiment, but may be a portable terminal that allows clerks to carry (handy terminal). It is especially preferable that when the operation terminal 61 is the portable terminal, customer's image is displayed on the image display 611 based on the image data contained in the request signal from the management system 3, as explained in “(3.3) Age verification process”. This enables clerks to confirm the face of the customer standing in front of the counter desk 7 by the image displayed on the image display 611, even from a location away from the counter desk 7 or a blind area of the counter desk 7.

In the abovementioned embodiment, when the display 27 displays information relevant to the customer putting the goods 9 in the basket body 21, the management system 3 associates the customer information with the display data, but the embodiment is not limited to this. For example, the shopping basket 2 may associate the customer information with the display data. In this case, the data receiver 26 may selectively receive only the display data relevant to the customer information acquired from pieces of display data transmitted from the data transmitter 35 through the customer information receiver 28.

The shopping basket 2 is not limited to the configuration that allows customers to carry with hand. For example, the shopping basket 2 may include, for example a basket body 21 provided integrally for a cart.

The cancel operation through the canceller 25 is not limited to making the goods information receiver 22 read goods information during the constant time starting when the cancel button is pushed or while the cancel button is being pushed. For example, when the image sensor included in the goods information receiver 22 acquires goods information, one or more goods 9 exiting from the basket body 21 can be automatically recognized from their images. Therefore, the cancel operation may be an operation of simply making one or more goods 9 exit from the basket body 21. Alternatively, when not only the goods identification code such as JAN code but also, for example goods name (or product name) or the like are recognized in the shopping basket 2, the cancel operation may be an operation of selecting one or more goods names to be deleted from a table (list) of goods names on the display 27.

The management system 3 is provided with the sensor 32, but the present embodiment is not limited to this. The shopping basket 2 may be provided with the sensor 32. When the shopping basket 2 is provided with the sensor, the transmitter 23 may be configured to, when the sensor senses that the basket body 21 is placed at the predetermined location, directly regard the sensed result as a trigger to transmit the pieces of goods information. In this case, the sensor may sense that the basket body 21 is placed at the predetermined location, for example according to On and Off of each of switches (e.g., push or magnet switches) provided for the basket body 21.

Preferably, the packing machine 4 further includes a holding mechanism configured to hold the bottom 82 of the bag 8 on the placement surface 411. The holding mechanism may be configured to hold the bottom 82 of the bag 8 on the placement surface 411 by, for example, adhesion, vacuum suction or the like. This configuration enables the bag 8 to be drawn into the inside of the guide 42 while suppressing the floating of the bottom 82 from the placement surface 411 when the support 41 moves downward relative to the guide 42, even if each item of goods 9 is comparatively small or light.

The communication system between the transmitter 23 and the receiver 31 is not limited to optical wireless communication whose medium is light, but may be radio communication whose medium is radio waves, wired communication, or the like. The communication system between the individual transmitter 231 and the individual receiver 311 is not limited to radio communication whose medium is radio waves, but may be optical wireless communication whose medium is light, or the like. When the communication system of the individual transmitter 231 is the same as the communication system of the transmitter 23 when the pieces of goods information is transmitted all together, one communication module that performs two-way communication with the management system 3 can be shared among the transmitter 23 and the individual transmitter 231. Similarly, one communication module that performs two-way communication with the shopping basket 2 can be shared among the receiver 31 and the individual receiver 311. The communication system between the data receiver 26 and the data transmitter 35 is not limited to radio communication whose medium is radio waves, but may be optical wireless communication whose medium is light, or the like.

The customer's input operation with respect to the management system 3 such as, for example, selection of cigarettes in the cigarette selling process, and selection of one or more specific goods in the specific goods selling process are not limited to the touch operation with respect to the display device 65 composed of the touch panel display. For example, the voice input through the voice input device 66 or a push operation with respect to a mechanical switch may be applied to at least part of the customer's input operation with respect to the management system 3.

The processes of the cigarette selling process, the specific goods selling process and the like are not necessarily required to be performed after the list is created at step S8 in FIG. 8 unlike the abovementioned embodiment, but may be performed before the list is created (i.e., prior to step S8).

The configuration in which for example, the management system 3 and the packing machine 4 are disposed inside one housing (counter desk 7) is not an essential configuration of the shopping assistance system 1, but components of the shopping assistance system 1 may be split and provided for houses. The configuration in which components of each of the management system 3 and the checkout processing system 5 are disposed inside one housing is not an essential configuration of the shopping assistance system 1, but components of each of the management system 3 and the checkout processing system 5 may be split and provided for houses.

Note that various modifications described above may be combined as appropriate.

### (5) Effect

As explained above, a shopping assistance system (1, 1A) according to a first aspect of the present invention includes a shopping basket (2, 2A), a management system (3, 3A) and a packing machine (4, 4A). The shopping basket (2, 2A) includes a basket body (21, 21A), a goods information receiver (22) and a transmitter (23). The basket body (21, 21A) allows goods (or products) (9) to be put in. The goods information receiver (22) is configured to read respective goods information (or product information) from each of the goods (9) to acquire pieces of goods information on the goods (9). The transmitter (23) is configured to transmit the pieces of goods information acquired through the goods information receiver (22). The management system (3, 3A) includes a receiver (31) configured to receive the pieces of goods information from the transmitter (23). The packing machine (4, 4A) is configured to transfer the goods (9) put in the basket body (21, 21A) together from the basket body (21, 21A) to a container.

This configuration enables the shopping basket (2, 2A), which allows the goods (9) to be put in, to acquire the pieces of goods information on the goods to transmit the pieces of goods information to the management system (3, 3A). In addition, the configuration enables the packing machine (4, 4A) to transfer the goods (9) put in the shopping basket (2, 2A) together from the basket body (21, 21A) to the container. That is, the shopping assistance system (1, 1A) is able to provide the management system (3, 3A) with the pieces of goods information on the goods (9) to be utilized for a checkout process or the like, without separating the goods (9) put in the shopping basket (2, 2A). Moreover, there is an advantage that enables reduction in shopping time because it is possible to transfer the goods (9) together to the container.

In a second aspect of the present invention according to the first aspect, the shopping basket (2, 2A) further includes a memory (24) configured to store the pieces of goods information.

This configuration enables the shopping basket (2, 2A) to transmit the pieces of goods information stored in the memory (24) all together to the management system (3, 3A).

In a third aspect of the present invention according to the second aspect, the shopping basket (2, 2A) or the management system (3, 3A) further includes a sensor (32) configured to sense whether or not the basket body (21, 21A) is placed at a predetermined location. Herein, the transmitter (23) is configured to, when the sensor (32) senses that the basket body (21, 21A) is placed at the predetermined location, then transmit the pieces of goods information.

With this configuration, it is possible to remove the operation forcing the shopping basket (2, 2A) to transmit the pieces of goods information because when the basket body (21, 21A) is placed at the predetermined location, the shopping basket (2, 2A) then automatically transmits the pieces of goods information to the management system (3, 3A).

In a fourth aspect of the present invention according to the second aspect or the third aspect, the shopping basket (2, 2A) further includes a canceller (25) configured to receive a cancel operation. The canceller (25) is configured to receive the cancel operation for deleting at least one piece of goods information from the pieces of goods information stored in the memory (24).

With this configuration, it is possible to delete, from the memory (24) by a cancel operation, even goods information acquired through the goods information receiver (22) to be stored in the memory (24).

In a fifth aspect of the present invention according to any one of the first to fourth aspects, the management system (3, 3A) further includes a price data receiver (33) and a list creator (34). The price data receiver (33) is configured to acquire, from an outside of the management system (3, 3A), price data representing respective prices of the goods (9) based on the pieces of goods information. The list creator (34) is configured to create a list based on the price data acquired through the price data receiver.

This configuration enables the management system (3, 3A) to create a list enumerating the respective prices of the goods (9) based on the price data acquired from the outside of the management system (3, 3A).

In a sixth aspect of the present invention according to any one of the first to fifth aspects, the packing machine (4, 4A) is configured to, when a checkout process of the goods (9) is completed, then complete a packing process of transferring the goods (9) from the basket body (21, 21A) to the container.

With this configuration, it is possible to prevent the goods (9) from being taken away along with the container before the checkout process is completed because the packing process is not completed before the checkout process is completed.

In a seventh aspect of the present invention according to any one of the first to sixth aspects, the packing machine (4, 4A) is configured to, based on the pieces of goods information, select the container for the goods to be put into from different types of containers.

This configuration enables the packing machine (4, 4A) to put the goods (9) in a container having, for example a shape, a size and color suitable for the goods (9).

In an eighth aspect of the present invention according to any one of the first to seventh aspects, the packing machine (4, 4A) further comprises a body mechanism (43) and a driver (44). The body mechanism (43) includes a support (41) formed with a placement surface (411) that allows the goods (9) to be placed on, and a guide (42) disposed around the support (41) along an outer peripheral edge of the placement surface (411). The driver (44) is configured to move at least one of the support (41) and the guide (42) to change a state of the body mechanism (43) from a first state to a second state. The second state is a state in which a location of the support (41) relative to the guide (42) is lower than that in the first state. The body mechanism (43) is configured to support a bottom (82) of a bag (8) as the container having an opening (81) at a top thereof by the placement surface (411) in a state where the bag (8) is upside down and covers the support (41) and the guide (42) from above. The body mechanism (43) is configured to change the state of the body mechanism (43) from the first state to the second state, thereby raising a lateral periphery (83) of the bag (8) upward from the bottom (82) by the guide (42). The lateral periphery (83) of the bag (8) is continuous with the bottom (82) of the bag (8). Thus, the body mechanism (43) is configured to put the goods (9) into the bag (8).

With this configuration, the support (41) moves downward relative to the guide (42), so that the bag (8) covering the support (41) and the guide (42) is drawn into an inside of the guide (42). At this moment, the lateral periphery (83) of the bag (8) is raised by the guide (42) around the support (41), and therefore the goods (9) placed on the placement surface (411) are put into the bag (8). It is therefore possible to relax the impact on the goods (9).

In a ninth aspect of the present invention according to any one of the first to eighth aspects, the basket body (21, 21A) includes a body (213, 213A) and a base plate (214, 214A). The body (213, 213A) is formed with an upper opening (211, 211A) and a lower opening (212, 212A) and allows the goods (9) to be put in. The base plate (214, 214A) is attached to the body (213, 213A) to allow opening and closing of the lower opening 212A. The lower opening (212, 212A) is formed to allow the goods (9) to pass through. When the base plate (214, 214A) closes the lower opening (212, 212A), an internal space surrounded by the body (213, 213A) and the base plate (214, 214A) allows the goods (9) to be put in. When the base plate (214, 214A) opens the lower opening (212A, 212A), the internal space allows the goods (9) to exit from through the lower opening (212, 212A).

With this configuration, it is unnecessary to pick the goods up one by one from the upper opening (211, 211A) of the basket body (21, 21A) when the goods (9) are transferred from the basket body (21, 21A) to the container because the lower opening (212, 212A) can be opened.

In a tenth aspect of the present invention according to any one of the first to ninth aspects, the management system (3, 3A) further includes a data transmitter (35) configured to transmit display data to the shopping basket (2, 2A). Herein, the shopping basket (2, 2A) further includes a data receiver (26) configured to receive the display data transmitted from the data transmitter (35), and a display (27) configured to perform display based on the display data received by the data receiver (26).

With this configuration, it is possible to provide customers carrying the shopping basket (2, 2A) with information from the shopping basket (2, 2A) because the display data transmitted from the management system (3, 3A) are displayed on the display (27) of the shopping basket (2, 2A).

In an eleventh aspect of the present invention according to the tenth aspects, the transmitter (23) includes an individual transmitter (231) configured to individually transmit the pieces of goods information. Herein, the receiver (31) includes an individual receiver (311) configured to individually receive the pieces of goods information. In addition, the data transmitter (35) is configured to transmit, as the display data, display data relevant to goods information, received by the individual receiver (311), of the pieces of goods information.

With this configuration, it is possible to provide customers carrying the shopping basket (2, 2A) with information relevant to the goods (9) because the display data relevant to each goods information are displayed on the display (27) of the shopping basket (2, 2A).

In a twelfth aspect of the present invention according to the tenth aspect or the eleventh aspect, the shopping basket (2, 2A) further includes a customer information receiver (28) configured to acquire customer information on a customer to put the goods (9) in the basket body (21, 21A). Herein, the data receiver (26) is configured to receive, as the display data, display data relevant to the customer information acquired through the customer information receiver (28).

With this configuration it is possible to provide customers carrying the shopping basket (2, 2A) with only information suitable for customers because the display data relevant to each customer information are displayed on the display (27) of the shopping basket (2, 2A).

In a thirteenth aspect of the present invention according to any one of the first to twelfth aspects, the shopping assistance system (1, 1A) further includes an operation terminal (61) configured to allow a clerk to enter an operation into. Herein, the management system (3, 3A) is configured to, when a specific item of goods (or a specific product) that requires permission of the clerk to purchase is selected along with the goods, then transmit a request signal to the operation terminal (61). The operation terminal (61) is configured to, when receiving the request signal and subsequently receiving a predetermined operation, then transmit a permission signal to the management system (3, 3A).

With this configuration it is possible to request the permission of the clerk by transmitting the request signal to the operation terminal (61) and causing the clerk to perform a necessary process such as the age verification process when a specific item of goods that requires the permission of the clerk to purchase is selected along with the goods (9).

In a fourteenth aspect of the present invention according to any one of the first to twelfth aspects, the shopping assistance system (1, 1A) further includes an operation terminal (61) configured to allow a clerk to enter an operation into. Herein, the management system (3, 3A) is configured to, when the goods include a specific item of goods that requires permission of the clerk to purchase, then transmit a request signal to the operation terminal (61). The operation terminal (61) is configured to, when receiving the request signal and subsequently receiving a predetermined operation, then transmit a permission signal to the management system (3, 3A).

With this configuration, it is possible to request the permission of the clerk by transmitting the request signal to the operation terminal (61) and causing the clerk to perform a necessary process such as the age verification process when the goods (9) put in the basket body (21, 21A) include a specific item of goods that requires the permission of the clerk to purchase.

In a fifteenth aspect of the present invention, according to the thirteenth aspect or the fourteenth aspect, the shopping assistance system (1, 1A) further includes an image capturing device (62, 62A) configured to photograph a customer. Herein, the management system (3, 3A) is configured to transmit the request signal containing image data photographed by the image capturing device (62, 62A). The operation terminal (61) includes an image display (611) configured to, when the request signal is received, then perform display based on the image data.

This configuration enables the clerk to confirm a customer's image through the image display (611) even from a location away from the customer or a blind area for the customer. Psychological crime prevention effect can also be expected because customers are photographed by the image capturing device (62, 62A).

In a sixteenth aspect of the present invention according to any one of the thirteenth to the fifteenth aspects, the management system (3, 3A) is configured to communicate with a checkout processing system (5) configured to perform a checkout process of the goods (9) based on the pieces of goods information. Herein, the management system (3, 3A) is configured to, when receiving no permission signal from the operation terminal (61), prohibit the checkout processing system (5) from starting a checkout process of the specific item of goods. The management system (3, 3A) is configured to, when receiving the permission signal from the operation terminal (61), cause the checkout processing system (5) to start the checkout process of the specific item of goods.

With this configuration, it is possible to prohibit the checkout processing system (5) from performing the checkout process until the clerk performs a predetermined operation for permission with respect to the operation terminal (61) when the customer purchases the specific item of goods that requires the permission of the clerk to purchase.

In a seventeenth aspect of the present invention according to any one of the first to the sixteenth aspects, the shopping assistance system (1, 1A) further includes a measuring device (63) configured to weigh the shopping basket (2, 2A) with the goods (9) put in the basket body (21, 21A). Herein, the management system (3, 3A) further includes a determining unit (39) configured to calculate total weight of the goods (9) from at least one piece of weight data corresponding to the pieces of the goods information to compare the total weight with a measurement value by the measuring device (63).

This configuration enables the management system (3, 3A) to judge whether or not the goods (9) actually put in the basket body (21, 21A) match goods (9) whose respective goods information is acquired through the goods information receiver (22).

In an eighteenth aspect of the present invention according to the seventeenth aspect, the determining unit (39) is configured to communicate with a checkout processing system (5) configured to perform a checkout process of the goods (9) based on the pieces of goods information. Herein, the determining unit (39) is configured to, when the total weight is out of a prescribed range based on the measurement value by the measuring device (63), prohibit the checkout processing system (5) from starting a checkout process of the goods (9). The determining unit (39) is configured to, when the total weight is in the prescribed range, cause the checkout processing system (5) to start the checkout process of the goods (9).

This configuration enables the checkout processing system (5) to perform the checkout process only when the goods (9) actually put in the basket body (21, 21A) match goods (9) whose respective goods information are acquired through the goods information receiver (22).

In a nineteenth aspect of the present invention according to any one of the first to the twelfth aspects, the management system (3, 3A) is configured to communicate with a checkout processing system (5) configured to perform a checkout process of the goods (9) based on the pieces of goods information. Herein, the management system (3, 3A) is configured to transmit the pieces of goods information received by at least the receiver (31) to the checkout processing system (5).

This configuration enables the management system (3, 3A) to utilize the pieces of goods information received through the receiver (31) for the checkout process by the checkout processing system (5).

In a twentieth aspect of the present invention according to any one of the first to the ninth aspects, the management system (3, 3A) further includes a display controller (371) and an inventory controller (30). The display controller (371) is configured to cause a display device (65, 65A) to display an on-screen menu that provides selection of at least one or more types of specific goods. The inventory controller (30) is configured to monitor respective inventory quantities of the one or more types of specific goods based on a sales history of the one or more types of specific goods. The display controller (371) is configured to vary contents of the on-screen menu based on a monitoring result by the inventory controller (30).

With this configuration, the display controller (371) excludes one or more types of specific goods out of stock from the on-screen menu, thereby avoiding a purchase operation being made wrongly with respect to such specific goods out of stock.

### REFERENCE SIGNS LIST

1, 1A Shopping assistance system
2, 2A Shopping basket
3, 3A Management system
4, 4A Packing machine
5 Checkout processing system
8 Bag (Container)
9 Goods
21, 21A Basket body
22 Goods information receiver
23 Transmitter
24 Memory
25 Canceller
26 Data receiver
27 Display
28 Customer information receiver
30 Inventory controller
31 Receiver
32 Sensor
33 Price data receiver
34 List creator
35 Data transmitter
39 Determining unit
41 Support
42 Guide
43 Body mechanism
44 Driver
61 Operation terminal
62, 62A Image capturing device
63 Measuring device
65, 65A Display device
81 Opening
82 Bottom
83 Lateral periphery
211, 211A Upper opening
212, 212A Lower opening
213, 213A Body
214, 214A Base plate
231 Individual transmitter
311 Individual receiver
371 Display controller
411 Placement surface
611 Image display

What is claimed is:

1. A shopping assistance system, comprising
a shopping basket including:
a basket body that allows goods to be put in;
a goods information receiver configured to read respective goods information from each of the goods to acquire pieces of goods information on the goods; and
a transmitter configured to transmit the pieces of goods information acquired through the goods information receiver,
a management system including a receiver configured to receive the pieces of goods information from the transmitter, and
a packing machine configured to transfer the goods put in the basket body together from the basket body to a container.

2. The shopping assistance system of claim 1, wherein the shopping basket further includes a memory configured to store the pieces of goods information.

3. The shopping assistance system of claim 2, wherein
the shopping basket or the management system further includes a sensor configured to sense whether or not the basket body is placed at a predetermined location, and
the transmitter is configured to, when the sensor senses that the basket body is placed at the predetermined location, then transmit the pieces of goods information.

4. The shopping assistance system of claim 2, wherein the shopping basket further includes a canceller configured to receive a cancel operation for deleting at least one piece of goods information from the pieces of goods information stored in the memory.

5. The shopping assistance system of claim 1, wherein the management system further includes
a price data receiver configured to acquire, from an outside of the management system, price data representing respective prices of the goods based on the pieces of goods information, and
a list creator configured to create a list based on the price data acquired through the price data receiver.

6. The shopping assistance system of claim 1, wherein the packing machine is configured to, when a checkout process of the goods is completed, then complete a packing process of transferring the goods from the basket body to the container.

7. The shopping assistance system of claim 1, wherein the packing machine is configured to, based on the pieces of goods information, select the container for the goods to be put into from different types of containers.

8. The shopping assistance system of claim 1, wherein the packing machine further comprises
a body mechanism including a support formed with a placement surface that allows the goods to be placed on, and a guide disposed around the support along an outer peripheral edge of the placement surface, and
a driver configured to move at least one of the support and the guide to change a state of the body mechanism from a first state to a second state in which a location of the support relative to the guide is lower than that in the first state, wherein
the body mechanism is configured to
support a bottom of a bag as the container having an opening at a top thereof by the placement surface in a state where the bag is upside down and covers the support and the guide from above,
change the state of the body mechanism from the first state to the second state, thereby raising a lateral periphery of the bag upward from the bottom of the bag by the guide to put the goods into the bag, the lateral periphery being continuous with the bottom.

9. The shopping assistance system of claim 1, wherein the basket body comprising
a body that is formed with an upper opening and a lower opening and allows the goods to be put in, and
a base plate attached to the body to allow opening and closing of the lower opening, wherein
the lower opening is formed to allow the goods to pass through, and
when the base plate closes the lower opening, an internal space surrounded by the body of the basket body and the base plate allows the goods to be put in, and
when the base plate opens the lower opening, the internal space allows the goods to exit from through the lower opening.

10. The shopping assistance system of claim 1, wherein
the management system further includes a data transmitter configured to transmit display data to the shopping basket, and
the shopping basket further includes
a data receiver configured to receive the display data transmitted from the data transmitter, and
a display configured to perform display based on the display data received by the data receiver.

11. The shopping assistance system of claim 10, wherein
the transmitter of the shopping basket includes an individual transmitter configured to individually transmit the pieces of goods information,
the receiver of the management system includes an individual receiver configured to individually receive the pieces of goods information, and
the data transmitter is configured to transmit, as the display data, display data relevant to goods information, received by the individual receiver, of the pieces of goods information.

12. A shopping assistance system of claim 10, wherein
the shopping basket further includes a customer information receiver configured to acquire customer information on a customer to put the goods in the basket body, and
the data receiver is configured to receive, as the display data, display data relevant to the customer information acquired through the customer information receiver.

13. The shopping assistance system of claim 1, further comprising an operation terminal configured to allow a clerk to enter an operation into, wherein
the management system is configured to, when a specific item of goods that requires permission of the clerk to purchase is selected along with the goods, then transmit a request signal to the operation terminal, and
the operation terminal is configured to, when receiving the request signal and subsequently receiving a predetermined operation, then transmit a permission signal to the management system.

14. The shopping assistance system of claim 1, further comprising an operation terminal configured to allow a clerk to enter an operation into, wherein
the management system is configured to, when the goods include a specific item of goods that requires permission of the clerk to purchase, then transmit a request signal to the operation terminal, and
the operation terminal is configured to, when receiving the request signal and subsequently receiving a predetermined operation, then transmit a permission signal to the management system.

15. The shopping assistance system of claim 13, further comprising an image capturing device configured to photograph a customer, wherein
the management system is configured to transmit the request signal containing image data photographed by the image capturing device, and
the operation terminal includes an image display configured to, when the request signal is received, then perform display based on the image data.

16. The shopping assistance system of claim 13, wherein
the management system is configured to communicate with a checkout processing system configured to perform a checkout process of the goods based on the pieces of goods information,
the management system being configured to:
when receiving no permission signal from the operation terminal, prohibit the checkout processing system from starting a checkout process of the specific item of goods; and
when receiving the permission signal from the operation terminal, cause the checkout processing system to start the checkout process of the specific item of goods.

17. The shopping assistance system of claim 1, further comprising a measuring device configured to weigh the shopping basket with the goods put in the basket body, wherein
the management system further includes a determining unit configured to calculate total weight of the goods from at least one piece of weight data corresponding to the pieces of the goods information to compare the total weight with a measurement value by the measuring device.

18. The shopping assistance system of claim 17, wherein
the determining unit is configured to communicate with a checkout processing system configured to perform a checkout process of the goods based on the pieces of goods information,
the determining unit being configured to:
when the total weight is out of a prescribed range based on the measurement value by the measuring device, prohibit the checkout processing system from starting a checkout process of the goods; and
when the total weight is in the prescribed range, cause the checkout processing system to start the checkout process of the goods.

19. The shopping assistance system of claim 1, wherein the management system is configured to communicate with a checkout processing system configured to perform a checkout process of the goods based on the pieces of goods information, the management system being configured to transmit the pieces of goods information received by at least the receiver of the management system to the checkout processing system.

20. The shopping assistance system of claim 1, wherein
the management system further includes
a display controller configured to cause a display device to display an on-screen menu that provides selection of at least one or more types of specific goods, and
an inventory controller configured to monitor respective inventory quantities of the one or more types of specific goods based on a sales history of the one or more types of specific goods, wherein
the display controller is configured to vary contents of the on-screen menu based on a monitoring result by the inventory controller.
